(19) United States
(12) Patent Application Publication
(10) Pub. No.: US 2024/0082920 A1
(43) Pub. Date: Mar. 14, 2024

(54) THERMAL STRESS AND SUBSTRATE DAMAGE REDUCING ADDITIVE MANUFACTURING METHOD

(71) Applicant: The Research Foundation for The State University of New York, Binghamton, NY (US)

(72) Inventors: Scott N. Schiffres, Vestal, NY (US); Arad Azizi, Alborz (IR); Changhong Ke, Binghamton, NY (US); Bahgat Sammakia, Binghamton, NY (US); Feilin Gou, Vestal, NY (US)

(21) Appl. No.: 18/318,670

(22) Filed: May 16, 2023

Related U.S. Application Data
(60) Provisional application No. 63/343,078, filed on May 17, 2022.

(51) Int. Cl. B22F 10/362; B22F 10/85; B33Y 40/10

(52) U.S. Cl. CPC B22F 10/362; B22F 10/85; B33Y 40/10; B33Y 50/02

(57) ABSTRACT

A technique for additively manufacturing with a segmentation exposure strategy is disclosed herein, which enables lower thermal stress and substrate temperatures, compared to conventional raster strategies. The technique enables manufacture of heat removal devices and other deposited structures, especially on heat sensitive substrates where coefficient of thermal expansion mismatch can be considerable. It also enables novel composites through additive manufacturing. This process can also be selectively applied to parts or material systems that have large thermal stresses with conventional raster and process parameters to reduce chances of thermal stress induced failure. The process enables reduction of heat concentration in selective laser melting or electron beam melting which results in lower residual stresses in the fabricated object.

### CROSS REFERENCE TO RELATED APPLICATIONS

The present application is a non-provisional of, and claims benefit of priority under 35 U.S.C. § 119(e) of U.S. Provisional Patent Application No. 63/343,078, filed May 17, 2022, the entirety of which is expressly incorporated herein by reference.

### STATEMENT REGARDING FEDERALLY SPONSORED RESEARCH

This invention was made with government support under Contract No. TI-1941181 awarded by the National Science Foundation. The government has certain rights in the invention.

### FIELD OF THE INVENTION

The present invention relates to the field of additive manufacturing, and more particularly to additive manufacturing by controlled focused energy (e.g., laser or electron beam) melting of particles, dissimilar substrate, specifically semiconductor substrates, ceramics, and glasses, or similar substrate, with reduced residual stress.

### INCORPORATION BY REFERENCE AND INTERPRETATION OF LANGUAGE

Citation or identification of any reference herein, in any section of this application, shall not be construed as an admission that such reference is necessarily available as prior art to the present application. The disclosures of each reference disclosed herein, whether U.S. or foreign patent literature, or non-patent literature, are hereby incorporated by reference in their entirety in this application, and shall be treated as if the entirety thereof forms a part of this application.

All cited or identified references are provided for their disclosure of technologies to enable practice of the present invention, to provide basis for claim language, and to make clear applicant's possession of the invention with respect to the various aggregates, combinations, and subcombinations of the respective disclosures or portions thereof (within a particular reference or across multiple references). The citation of references is intended to be part of the disclosure of the invention, and not merely supplementary background information. The incorporation by reference does not extend to teachings which are inconsistent with the invention as expressly described herein (which may be treated as counter examples), and is evidence of a proper interpretation by persons of ordinary skill in the art of the terms, phrase and concepts discussed herein, without being limiting as the sole interpretation available.

The present specification is not to be interpreted by recourse to lay dictionaries in preference to field-specific dictionaries or usage. Where a conflict of interpretation exists, the hierarchy of resolution shall be the express specification, references cited for propositions, incorporated references, the inventors' prior publications relating to the field, academic literature in the field, commercial literature in the field, field-specific dictionaries, lay literature in the field, general purpose dictionaries, and common understanding. Where the issue of interpretation of claim amendments arises, the hierarchy is modified to include arguments made during the prosecution and accepted without retained recourse.

### BACKGROUND OF THE INVENTION

Low-temperature bonding metal alloys can be printed onto semiconductor or ceramic substrates using active elements such as Ti, Zr, V, Nv, Hf, Ta, Mo, Cr, and W. The active alloy may form intermetallic compounds such as silicides on Si and SiC, and carbides on graphite, and diamond, or amorphized mixtures of the substrate and reactive metal elements on the surface of many dissimilar substrates. After printing of the low-melt alloy, the powder material to be sintered can be switched to high conductivity metals such Al, Cu, and their alloys to form high conductivity structures onto the low-melt interlayer alloy [1,2].

Thermal stresses in laser or electron based additive manufacturing processes such as selective laser melting, and electron beam melting is an important consideration [3,4]. In powder bed fusion systems, a thin layer of powder (usually metal) is deposited onto a similar or dissimilar substrate by a recoating or deposition mechanism. The laser or electron beam which is redirected by the optics in the printer is focused on the focal plane which is the powder on the substrate or the slice of solid part that is being built. The laser or electron beam melts and fuses the powder to the substrate or the prior slice of the solid part. The laser or electron beam moves across the focal plane by a beam steering mechanism, such as galvo mirror system, to create a geometry or pattern at that specific to each slice of the build.

Due to high laser energy input on the part in the layer-by-layer build for thermal additive manufacturing techniques, like selective laser melting and electron beam melting, the object that is under print heats up. The thermal gradient in the object as a result of heat input during the print by laser or electron beam, thermal stresses form in the object and at the interface of the object and the substrate. These thermal stresses are due to the coefficient of thermal expansion associated with the object and the substrate materials, the local temperature distribution in each of the mentioned components, and the mechanical properties of the material. In some cases, the process causes a chemical change in the material which forms the layer, which can also lead to residual stress.

Powder bed fusion printer software are generally designed to optimize the laser or electron beam scan pattern to minimize print time due to the high cost associated with the print process itself, such as machine time, technician time, and protective gas flow inside the print chamber. As a result, the printer software generally tends to reduce the time of the print, aside from cursory chessboard raster patterns. However, such software does not minimize the effect of laser or electron beam scanning pattern on the thermal stresses enough for delicate applications involving dissimilar and brittle materials.

Not taking into account thermal stresses can lead to catastrophic results such as failure of some part or an entire print, and possible damage to the printer, especially the recoating system.

Currently, the simulation software used for evaluation of thermal stresses in an object provides information based on the geometry, but they do not take into account the laser or electron beam pattern [5-7]. As a result, the current state of the art in the industry is to optimize the geometry itself in terms of shape and orientation on the build plate to reduce thermal stresses associated with the print process. However, current commercial software packages are not practical for geometries that cannot be modified or for the substrates that are sensitive to smallest heat input such as semiconductor chips.

There have been some studies on the effect of laser or electron beam scanning pattern on thermal stresses, but they were very limited and did not address the problem sufficiently for dissimilar material bonding. Example of such laser scanning patterns are provided in FIGS. 1A-1F, with exemplary processing parameters laser power 100W, Spot size 0.6 mm, Scan speed 50 mm/sec, Scan spacing 0.1 mm, part dimensions 35×15 mm², plate dimensions 45×22×1 mm², Sector dimensions 5×5 mm² or 2.5×2.5 mm². Yao, U.S. 2015/0286757 provides a method for efficiently predicting the quality of additively manufactured metal products. The method numerically models the Direct Metal Additive Manufacturing process with the layer-by-layer building of the metal products, separating the global macro-scale modeling and the local micro-scale modeling, with a database to link in between. The database containing the micro-scale modeling results can be established well before the global scale product simulation is conducted, and therefore the global modeling and database may be used to simulate the additive manufacturing of the whole product, without using the time-consuming micro-scale modeling simultaneously.

Direct Metal Additive Manufacturing (DMAM) applies the metal powder by spreading a layer or spraying directly on solids, and applies a point heat source of laser or electron-beam at selected locations to melt the powder onto the partially made products. Then, another layer of metal is added on top of this layer. The significant challenges of product qualities are the distortions or fracturing as well as the undesirable micro-structures of the products, arising from significant residual stress and uncontrolled phase transformation during freezing and cooling.

When the point heat source applied to the powder or solid surface a molten metal pool is formed. The local freezing process of the melt pool could determine the local crystalline structure of the material. When the molten pool starts to freeze there is no stress, but the surrounding metal is at a temperature much below the molten temperature of the freezing pool. After the product is eventually cooled to the room temperature, the material in the previous pool region experiences much more temperature drop than its surrounding metals, and more reduction of density occurs in the previous pool region due to the presence of the thermal expansion coefficient. Due to the uneven shrinkages, thermal stress occurs.

On the other hand, due to the repeated building of the thin layers at the top, the material at a location of a particular layer experiences heating-cooling cycles repeatedly in time, with each temperature peak lower than the one before due to the increased distance of the top layer during the buildup. The phase of the material at this point is transformed continuously in the heating-cooling cycles until the temperature excursion of a cycle is too low to cause the phase transformation. The resulting final microstructure is then determined, but may not be desirable.

Usually, the industry practice takes several trials of fabrication to have a good product developed. As such, new approaches are required to mitigate and control the product distortions and microstructures.

The DMAM process involves the sweeping of a point heat source of laser or e-beam in the form of a line or continuous dots to a layer of metal powder on solid surface, where the molten powder metal merges with the previous layer of product at below. Generally, the process parameters involved in DMAM are at both the local and global levels. The local parameters, which are located near the point heat source, are typically the material, the powder sizes, the layer thickness, the heat source power, size, and speed, and the local initial solid temperature before the heat is applied. On the other hand, the global parameters of the process are the point heat source sweeping pattern as well as the already built structures under the layer and its cooling process. Since the local residual stress is controlled by the properties of the molten pool and its cooling process, which are influenced by both the local and global process parameters, the local and global process simulation are well coupled and need be conducted simultaneously. Furthermore, the local and global process and phenomena could be numerically modeled together based upon the first principles. However, a critical problem of the process simulation is the computational time involved. The coupled thermal and stress modeling are performed simultaneously on the global and local scales. The local micro-scale modeling near the point heat source requires very fine meshes and very small time steps (in the order of micro-meter and milliseconds), but has to cover all the locations on each layer and all the layers of a product (in the order of centi-meter and minutes). The simulation can be very time consuming, and typically is not available in real time using feasible technology. See Yin, H., Wang, L., and Felicelli, S. D., “Comparison of Two-dimensional and Three-dimensional Thermal Models of the LENS Process,” Journal of Heat Transfer, Vol. 130, 102101-1, October 2008; Beuth, J., Flanagan, H. L., “Process Mapping of Melt Pool Geometry,” International Patent Application No. PCT/US2012/048658, Pub. No. WO/2013/019663; J. Sieniawski, W. Ziaja, K. Kubiak, and M. Motyka, “Microstructure and Mechanical Properties of High Strength Two-Phase Titanium Alloys,” Titanium Alloys-Advances In Properties Control, Chapter 4, ISBN 978-953-51-1110-8, 2013.

Bar, et al. U.S. 2020/0338638 relates to a 3D-metal-printing method and arrangement for producing a spatial metal product substantially consisting of a metal powder or metal filaments, the powder or the filaments being structured layer-by-layer by application of starting material layers to a respectively previously produced layer and selective local heating of predefined points of the layer above a sintering or melting temperature of the powder and fusion of the molten points with the underlying layer and optional tempering of the points, in which the respectively newly applied starting material layer and optionally at least one underlying layer are preheated by planar or migratory irradiation of near-IR radiation, particularly with a maximum radiation density in the wavelength range of between 0.8 and 1.5 μm, to a temperature with a predetermined difference to the melting temperature and/or points predefined in connection with the local heating are subjected to an aftertreatment for thermal voltage compensation. This achieves thermal stress equalization.

Li, et al., U.S. 2021/0170495 relates to a method for forming a multi-material part by selective laser melting includes the following steps. Modeling is performed by regularly distributing and arraying a combination of materials that meets forming requirements such that a part model is designed. The designed part model is subjected to a dimension compensation, a shape compensation, a chamfering setting, a margin design and a design of a process support to obtain a process model. The obtained process model is sliced into a series of layers. Type, distribution and boundary information of materials in each layer are collected to generate a control file. All materials required for part forming are loaded into an additive manufacturing equipment. After a state of the additive manufacturing equipment meets forming requirements, a part is formed under the control of the generated control file. Post-processing is performed after the part is formed.

Zhang et al. studied the effect of scanning strategies on temperature, residual stresses and deformation in multi laser powder bed fusion systems [8]. In their study, they concluded that in order to obtain the lowest temperature rise, the two laser beams should be spaced apart from each other. It is also mentioned that proximity of laser beams to each other affects the temperature peak due to localized energy concentration resulting in larger temperature rise. More importantly, it is concluded in their numerical study that a delayed scanning strategy is beneficial for reducing residual stress due to longer cooling times.

Cheng et. al. studied different scan strategies such as island scanning, line scanning, 45° line scan, 45° rotating line scan, 90° line scan, 90° rotating line scan, 67° line scan, 67° rotating line scan, spiral out from the center (in-out) scan, and spiral in from the perimeter (out-in) scan [9]. The spiral out from the center (out-in) had the highest maximum stresses along the X and Y directions and 45° line scan had the minimum residual stresses in both directions.

Carter et.al. studied the influence of laser scan strategy on grain structure and cracking behavior of nickel superalloy [10]. They observed a bimodal texture in the island laser scanning strategy based on electron backscatter diffraction (EBSD) data. Coarse elongated grains with preferential orientation in the build direction and fine grains in the boundary region were identified. Micro-Computed Tomography (Micro-CT) data showed the distribution of cracks were on the fine-grained regions showing the effect of scanning strategy on microstructure and cooling rates in the selective laser melted parts.

Parry et.al. investigated the effect of laser scan strategy on residual stresses in the selective laser melting by simulation [11]. Two laser scan strategies (a) unidirectional, and (b) alternating were studied. They observed a relation between the frequency of temperature oscillations and the scan vector length. It was seen that the longitudinal stresses increased with the scan vector length due to larger thermal gradient parallel to the laser scan direction. Furthermore, thermal history due to the type of laser scan strategy was seen as the dominating factor resulting in varying distribution of stress and plastic strain.

Ramos et.al. studied five different laser scan strategies by simulation including unidirectional, zigzag, alternating and intermittent for 1 and 0.1 mm of vector length with the goal of reducing residual stresses [12]. They observed that the intermittent strategy with 0.1 mm vector length generated lower residual stress and deformation. The intermittent strategy with short vector length provided 10% and 42% less deformation compared to the alternating and unidirectional laser scanning schemes respectively. This reduction is due to minimization of heat concentration generated by laser exposure in the short vector intermittent strategy. Ma and Bin studied continuous fractal vector paths and found fractal patterns reduced the z-deformation by about 56% [13].

US 20170232515 provides an additive manufacturing simulation system and method, which uses a two-dimensional energy patterning system, such as a spatial light modulator (SLM), e.g., light valve or digital micromirror devices. Information related to a part is provided, with the information including CAD files, material type, selected additive manufacturing process type, and tolerances of selected design features. Manufacture of a part is simulated and compared to selected design tolerance. If the simulated manufactured part is outside selected design tolerances, simulation parameters can be adjusted until results indicate the simulated manufactured part is within selected design tolerances. In certain embodiments, manufacturing the part uses a real-time sensor monitoring system, along with post processing analysis of selected design features to improve simulated manufacture of the part.

The powder bed fusion (PBF) technique for additive manufacturing of metals, ceramics, and plastics is well suited for manufacture of a wide range of parts. Thermal expansion and the buildup of internal stresses are difficult to computationally model in complex parts, but ignoring or failing to compensate for these issues can result in weak or failed parts.

Accurate modeling can involve capturing the effects of surface tension, photon absorption, emission, reflection, transmission, scattering, thermal conduction in the gas/powder particles/previous layer(s), advection of the gas, thermal expansion of the powder particles and the previous layer(s), phase change including melting, gasification, condensation, and solidification, and in cases of high temperature melting materials (such as metals/ceramics), thermal radiation heat transfer. Other physics such as gas photon absorption, buoyancy, and if ceramics are to be modeled accurately, chemistry needs to be involved.

Finite Element Analysis (FEA) can be used for static structural problems, and Computational Fluid Dynamics (CFD) for fluid flow. However, to accurately solve for the resultant stress distributions and geometry after an additively manufactured part has cooled, the thermal history of the part is required. Thermal history calculations require a full suite of physics modeling, which is not captured by conventional FEA and CFD analyses.

An additive manufacturing system which has one or more energy sources, including in one embodiment, one or more laser or electron beams, are positioned to emit one or more energy beams. Beam shaping optics may receive the one or more energy beams from the energy source and form a single beam. An energy patterning unit receives or generates the single beam and transfers a two-dimensional pattern to the beam, and may reject the unused energy not in the pattern. An image relay receives the two-dimensional patterned beam and focuses it as a two-dimensional image to a desired location on a height fixed or movable build platform (e.g. a powder bed). In certain embodiments, some or all of any rejected energy from the energy patterning unit is reused.

In some embodiments of US 20170232515, multiple beams from the laser array(s) are combined using a beam homogenizer. This combined beam can be directed at an energy patterning unit that includes either a transmissive or reflective pixel addressable light valve. The pixel addressable light valve may include both a liquid crystal module having a polarizing element and a light projection unit providing a two-dimensional input pattern. The two-dimensional image focused by the image relay can be sequentially directed toward multiple locations on a powder bed to build a 3D structure.

Wang, WO2021097248 provides a method for processing an input signal using a finite element model (FEM) to generate an output signal. The input signal, the output signal, and the FEM are associated with a simulated additive manufacturing process. The method also includes adjusting the input signal based on comparing the output signal to a reference signal and thereafter processing the input signal using the FEM to generate the output signal. Examples also include a computer readable medium and a computing device related to the method.

FEM is a numerical method for solving boundary value problems involving partial differential equations that characterize phenomena such as heat transfer, thermal stress, and fluid flow. FEM is applied to predict the results of a simulated additive manufacturing process. The FEM predicts how the powder material reacts to the energy beam characterized by the input signal. The output signal generally represents results of the simulated AM process at a given point in time and/or at a given position within the precursor material. In a powder bed fusion (PBF) example, the output signal can represent physical characteristics of a melt pool of the powder bed. The melt pool refers to an area or volume of the powder bed that has been fused together to form a portion of the component. As such, the output signal can represent a width of a melt pool, a depth of the melt pool, an area of the melt pool, and/or a volume of the melt pool (e.g., at a given point in time). Additionally or alternatively, the output signal could represent a thermal stress, a temperature (e.g., average or peak temperature), a shape, or a porosity' of the powder bed at particular locations.

The input signal is adjusted based on comparing the output signal (e.g., an observed width of a melt pool) to a reference signal (e.g., a target width of the melt pool). For example, a proportional-integral-differential (PID) controller and/or a repetitive control algorithm can be used to adjust the input signal based on a difference between the output signal and the reference signal. Conventionally, FEM can take hours or even days to simulate the printing of a few layers of a component that occurs in a few seconds in reality. Thus, it has been challenging to integrate FEM with closed-loop control that can be implemented in real-time. Wang suggests an iterative bi-directional computation where FEM and feedback controls are updated at equal time intervals (e.g., Ts). Therein, the FEM output signal is processed by the feedback control to generate a new input signal. Then the new input signal is sent back to the FEM, and a new FEM calculation (also with computation time Ts) begins. In this manner, step by step, the FEM is implemented and the time scale between FEM and feedback control synchronized. Mamrak, U.S. 2018/0264598 provides an improved scanning strategy, having a waveform hatch pattern for scanning an energy source during an additive manufacturing build process. A waveform hatch pattern is formed on each layer of the build so as to increase the variance between layers and/or improve the microstructure of the completed component. In one aspect, a first layer is formed by scanning a laser in a series of hatch lines formed as a first pattern that oscillates about an axis. Each subsequent layer is formed as a series hatch lines formed in a pattern that is varied in geometry from a previous and subsequently formed layer. By varying the pattern when forming each layer, the desired variance in each layer can be achieved.

Selective laser sintering, direct laser sintering, selective laser melting, and direct laser melting are common industry terms used to refer to producing three-dimensional (3D) objects by using a laser beam to sinter or melt a fine powder. For example, U.S. Pat. No. 4,863,538 and U.S. Pat. No. 5,460,758 describe conventional laser sintering techniques. More specifically, sintering entails fusing (agglomerating) particles of a powder at a temperature below the melting point of the powder material, whereas melting entails fully melting particles of a powder to form a solid homogeneous mass. The physical processes associated with laser sintering or laser melting include heat transfer to a powder material and then either sintering or melting the powder material. Electron beam melting (EBM) utilizes a focused electron beam to melt powder. These processes involve melting layers of powder successively to build an object in a metal powder.

AM techniques may be characterized by using a laser or an energy source to generate heat in the powder to at least partially melt the material. Accordingly, high concentrations of heat are generated in the fine powder over a short period of time. The high temperature gradients within the powder during buildup of the component may have a significant impact on the microstructure of the completed component. Rapid heating and solidification may cause high thermal stress and cause localized non-equilibrium phases throughout the solidified material. Further, since the orientation of the grains in a completed AM component may be controlled by the direction of heat conduction in the material, the scanning strategy of the laser in an AM apparatus and technique becomes an important method of controlling microstructure of the AM built component. Controlling the scanning strategy in an AM apparatus is further crucial for developing a component free of material defects, examples of defects may include lack of fusion porosity and/or boiling porosity. A laser and/or energy source is generally controlled to form a series of solidification lines in a layer of powder based on a pattern. A pattern may be selected to decrease build time, to improve or control the material properties of the solidified material, to reduce stresses in the completed material, and/or to reduce wear on the laser, and/or galvanometer scanner and/or electron-beam. Various scanning strategies have been contemplated in the past, and include, for example, chessboard patters and/or stripe patterns.

One attempt at controlling the stresses within the material of the built AM component involves the rotation of stripe regions containing a plurality of adjoining parallel vectors, as solidification lines, that run perpendicular to solidification lines forming the boundaries of the stripe region. for each layer during an AM build process. Parallel solidification lines, bounded by and perpendicular to a stripe, are rotated for each layer of the AM build. One example of controlling the scanning strategy in an AM apparatus is disclosed in U.S. Pat. No. 8,034,279 B2.

One challenge associated with laser-based AM is producing a desired melt pattern in the powder while maintaining a desired speed of the build process. The buildup of heat within the powder and fused material during a build is a concern, as various material defects may occur if too much heat is built up in the material during an AM process and/or if insufficient heat is built up to properly fuse the powder. Since variance of the scan pattern in each build layer is generally desirable during an AM build, a waveform shaped scan pattern is used to create variance in the AM build layers, and by controlling the speed of the laser, the laser power, and the period, frequency, and amplitude of the waveform scan pattern, desirable material properties and efficiency of the build is achieved.

Mamrak employs a scanning strategy, having a waveform hatch pattern for scanning a laser during an AM build process. When controlling the laser during the build process according to one embodiment, a waveform hatch pattern is formed on each layer so as to increase the variance between layers and improve the microstructure of the completed component. In one aspect, a first layer is formed by scanning a laser in a series of hatch lines formed as a smooth repetitive oscillation (e.g., as a sinusoidal wave). Each subsequent layer may have the series hatch lines formed as a differing sinusoidal and/or smooth repetitive oscillating pattern. For example, any one or a combination of the amplitude, frequency, angular frequency and/or phase of the sinusoidal pattern may be varied in each layer of the build. By varying the pattern when forming each layer, the desired variance in each layer can be achieved. See also U.S. 20210039166; EP3595869; WO2018169630; U.S. Pat. No. 10,828,700; EP3592488; U.S. Pat. No. 10,668,534; EP3592487; U.S. 20180250742; WO2018164770; US 20180250743; WO2018164774;

In certain embodiments, the additive manufacturing machine can be programmed to adjust laser power flux and dwell time, print order among other machine parameters during the manufacturing process, as well as support structure, orientation, and overall part topology among other geometrical parameters during the part pre-processing. These adjustments can be guided with reference to a physics model optimized for additive manufacturing processes, including but not limited to powder bed fusion. For example, the additive manufacturing process can be simulated using data related to the Computer Aided Design (CAD) geometry for the powder bed, material type, printer model (or printer capabilities), and desired resultant material properties such as stress distribution, thermal warpage, or crystal structure. Simulation results can be compared to a part material specification, and power flux, dwell time, and print order along with other geometrical parameters such as part orientation, support structure, and part topology can be adjusted in the simulated machine and the simulation repeated. Machine learning algorithms can allow for previous simulations (and the results of previous experiments stored in databases) to be accessed by these algorithms to minimize the number of cycles required, and allow for faster convergence on the optimum manufacturing parameters to create the desired parts with the desired properties.

If part functionality requirements are also known, another level of simulation can be carried out to optimize the design of the part for both the end use case, and for the additive manufacturing process. As an example, a part could benefit from various levels of internal pre-stressing developed/imbedded during the additive manufacturing process, the use of which would be realized in the end-use application. A stress state throughout the part can be specified to be within a specific tolerance, and in certain embodiments a part can be manufactured to have a two or three-dimensional stress map within a given tolerance or spatially defined set of tolerances.

Sensor monitoring for in-process control can monitor both an area currently being printed (i.e., illuminated with an energy beam such as laser light or e-beam), and the next area to be printed. Careful measurement of the next location to be printed, correlated with simulation and table value lookup can aid in adjusting the print schedule on the fly, adjusting the delivered power flux to match the temperature in upcoming zones to alleviate over/under melting scenarios which lead to degradation in part resolution and increase of thermally induced stresses. Other examples of potential actions include selective changes to the heating/cooling of zones in the chamber walls, substrate, or ceiling to spatially manage heat loss.

### SUMMARY OF THE INVENTION

The present technology provides methods for reduction of thermal stresses during the fabrication process by selective laser melting or electron beam melting process. It also prevents damaging temperature excursions of thermally sensitive substrates.

All prior additive manufacturing thermal stress reduction literature looked solely at minimizing thermal stresses, not at minimizing temperature. For applications on thermally sensitive substrates, like electronic chips, temperature can also thermally damage the device by damaging transistors, interconnects, solder and C4 connections. Moreover, existing laser raster strategies available on commercial machines laser powder bed fusion printer fail to produce strong bonding of larger features between silicon substrates and metal printed alloys, due to thermal stress buildup (e.g., 1 mm diameter pin fins).

The process operates by segmenting or dividing parts into multiple laser scanning regions that are not thermally adjacent, to increase the time each printed voxel has to cool down, which results in smaller regions that are shrinking upon cool down, lower temperature gradients and hence lower thermal stresses. Additionally, this strategy also reduces maximum temperatures, lowering the risk to substrates that are thermally sensitive.

Thermal stresses in laser or electron beam additive manufacturing occur mainly due to three reasons which are interconnected. First, thermal gradient due to the laser or electron beam scan length; Second, localized heat build-up because of laser scanning strategy and geometry of the object; Third, magnitude of the coefficient of thermal expansion; and Fourth, mismatch in coefficient of thermal expansion in dissimilar substrates or composites.

The technology presented herein solves these challenges by proposing a novel laser or electron beam scanning strategy. The rate of expansion and contraction of a material is function of temperature according to ΔL=αLΔT, wherein ΔL is the change in length L, ΔT is the change in temperature, and α is for coefficient of thermal expansion. [3]. By minimizing the temperature gradient during selective laser melting or electron beam melting, the associated strain will be reduced.

There are three common scanning patterns that are currently being used in the mentioned additive manufacturing processes. Unidirectional line scan, alternating line scan and island scan with 0 degrees rotation after each layer. Common values for 0 are 45, 67, and 90 degrees. In the mentioned scan patterns, localized heat concentration is inevitable due to multiple laser or electron beam scan in a short period of time [11]. In the present scanning strategy, the laser or electron beam will jump across the object's cross section at each layer with delay to provide enough time for cool down and minimize the heat build-up effects. After each single scan vector, the heat source will jump across the surface to scan another location in the build platform with enough distance to minimize the heat build-up. Additionally, an optional delay of P microseconds is included after each scan vector to ensure the cool down condition is satisfied. In printers without this functionality, the delay can be implemented with inclusion of a dummy part in the design file.

This time delay is especially important for objects with small dimensions as the total length of scan vector can be small. The shape of the scanning vector can be in the form of straight line, or a curve based on the object's geometry. The direction of the scanning vector and start and end locations can be changed with each layer to ensure proper fusion and minimize porosity.

In the present technology, a predictive loop is designed to obtain the cool down time required for the segmentation strategy. Machine learning algorithms in conjunction with multiphysics simulations can be applied to find out the exact time required for cooling. As a result, the multiphysics software may be integrated with the printer exposure strategy software. Alternatively, a user selected empirical spacing between neighboring segments can be described.

One strategy is to find the required cool down time around a print line to meet certain objectives, then exclude the printer from printing within this region for pre-determined time period. This can be done alternatively by experimental methods including high throughput testing of specific print patterns for specific geometries, in-situ thermography-based systems such as bed monitoring and melt pool monitoring.

The scanning strategy is specifically important for additive manufacturing of composites and also printing onto dissimilar substrates. Semiconductor substrates such as silicon have low coefficient of thermal expansion (2.62×10⁻⁶ K⁻¹ at 300 K), on the other hand, high conductivity metals often used in electronics manufacturing such as copper have high coefficient of thermal expansion (˜24×10⁻⁶ K⁻¹ at 300 K) [14]. This difference in coefficient of thermal expansion increases the effect of thermal stresses at the interface which can cause delamination or damage to the heat sensitive substrate, something that single material additive does not have to contend with.

In the following examples implementation of the segmentation exposure strategy technology to reduce thermal stresses is discussed. By printing neighboring sections in smaller regions, it relieves the stress in the adjacent print region, lowering the effective length of the thermal stressed region.

For instance, as illustrated in FIGS. 2A and 2B, the regions can be sub-divided into smaller domains and elements of that domain can be further segmented into sub-domains. The sub-domain segments can be done in a non-sequential manner. In FIGS. 2A and 2B, the regions with letters A-I are domains, and the numbered regions in these domains are sub-domains. The laser scan order is, with optional pauses between raster paths:
E1, C1, G1, I1, A1, B1, D1, H1, F1
E2, C2, G2, I2, A2, B2, D2, H2, F2
E3, C3, G3, I3, A3, B3, D3, H3, F3

Raster paths could be further segmented into dashed lines.

Pause duration could be based on cooling time to prevent substrate excess temperatures and/or thermal stress.

The segmentation into domains and sub-segmentation into sub-domains can be done with different geometrical or shape primitives to fit the geometry. These primitives can combine into shapes like squares (e.g., FIG. 2A), circles (e.g., FIG. 2B), and can even consist of individual pixel points. The primitives can also be further segmented into sub-sub-domains, or further levels of segmentation, though this is not pictured and not necessarily desirable, as jumping between segments consumes print time.

As shown in FIG. 2C, a flowchart shows an exemplary method. The layer to be manufactured is segmented into domains 201. The domains are defined by a domain shape basis set 202 and a domain maximum size 203. The basis set shapes are translated and scaled, and in some cases rotated, as appropriate. The domains are then segmented into sub-domains 204, with the sub-domains having a shape basis and nesting basis 205. Nesting basis defines how subdomains nest and enclose other sub-domains to maximize or optimize annealing of previously exposed regions. The exposures are then ordered 206, according to separation variables between domains 207 and separation variables between sub-domains 208. Separation variables can be expressed in terms of spatial and temporal variables. Separations can be defined to minimize a cost function that is a function of thermal overlap and repositioning time. Therefore, the scheme seeks to avoid excess thermal stress in a localized region by limiting the amount of power delivered to that localized region before it can cool. The input thermal energy is delivered in clusters, which minimizes repositioning time, until the measured, imputed or presumed limit is reached. The limit may be a temperature per se, a thermal stress, or some other thermal-dependent variable. Since the layer is deposited as a set of features, often deposited as adjacent spots in a line, it is convenient to limit the cluster according to line boundaries, even if the thermal-related limit is not reached. Once the thermal limit is reached, the spot is moved away from the heated region, typically far enough away such that the heating of the subsequent region does not impair the cooling of the previous heated region, and the heat from the previous heated region does not further limit the heating of the subsequent region before it reaches its thermal-related limit. Of course, there will be thermal overlap in any physical system, and the exposure ordering queue takes account of these possible interactions. The process waits until the initial region is sufficiently cooled before the next line of spots is placed adjacent to the now cooled initial region. Dependent on the details, there may be a single intervening region or multiple regions.

In some cases, the optimum temperature of the region for forming the layer is not the minimum feasible temperature, and therefore the subsequent adjacent spots are preferably deposited within a time window (allowing temperature drop) after the previous spots. This can also be accounted for in the exposure ordering queue.

Within the thermal constraints, it is generally true that the repositioning distance positively correlates with settling time for subsequent exposure, and therefore the ordering of the queue can optimize the build time. Note that in a complex build, a comprehensive ordering algorithm may be an NP complete or NP hard problem, but a full combinatorial analysis is not required for effective operation. Rather, a preference is provided for regular patterns of processing, for example, cycling between four discrete regions of a layer and sequentially processing lines on each of the four regions before returning to the initial region. If the regions have common features, then the processing would complete for each region at about the same time; on the other hand, if one of the regions is sparse, and the other is dense, then the sparse region may be completed first. This can be addressed in the ordering algorithm, which plans the entire layer and ensures that expected grossly suboptimal results are predicted and compensated. Minor deviations from an optimal cost (e.g., build time) result may be permitted in order to obtain predictability of operation.

FIG. 2D a shows a domain-level process (i.e., without sub-domains) for a region of a layer. A layer is segmented into domains 210, according to a domain shape basis set 211 and a domain maximum size 212. The basis set shapes are translated and scaled, and in some cases rotated, as appropriate. The exposure of the domains is then ordered 213, according to separation variables between domains 214. In this case, the ordering may insert null operations if there are no other regions to build, or multiplex processing of other regions in the required delay between clusters of energy pulses.

Note that the ordering is typically predetermined, when the layer is being planned. However, the exposure ordering system may be adaptive, e.g., based on sensor input or other feedback. For example, a non-contact optical thermometer may be used to compare a predicted temperature of a region with the measured temperature. The exposure order queue may be modified based on deviations from the predicted value. The exposure ordering queue may create (and/or update) a plurality of plans, which are selected based on the error signal.

The exposure ordering system may also be responsive to quality control feedback or feedback based on a test piece/first article testing. Therefore, in some cases, various features may be aggressively manufactured, with empirical testing to ensure quality and performance. Assuming that the limiting regions are predictable, and the thermal stress effects known, the feedback may be efficiently available through manual or automated means.

The exposure ordering queue may be optimized using standard software or purpose-built code.

See, [16], [17], [18], [19], [20], [21], [22], [23], [24], [25], [26, [27], [28], [29], [30], [31], [32], [33], [34], [35], [36], [37].

The current generation of laser path generation software is empirical. All the process parameters of typical laser powder bed fusion manufacturers are empirical. For instance, the manufacturers have users set laser scan speed, laser power, and hatch spacing for different types of laser exposures (outer skin, top surface, bottom surface, support, etc.). The software also asks for the size of exposure regions and the angular rotation of subsequent regions that are printed on top of those regions (e.g., 60° rotation with every build layer in the raster direction). Current software does not have a setting providing temporal or spatial separation capability, which is provided according to the present technology.

In order to maintain compatibility with such legacy systems, one implementation of the technology encompasses an algorithm that divides the space into nested regions, and which permits user defined temporal and spatial separation variables, to achieve low residual stress and temperature excursions in the substrate.

A pre-calculated temperature or stress limit may also be implemented, which would then require that the control system permit adaptive process control. The segmentation process may provide different regions (which may be arbitrary or not topologically defined or constrained) with an automatically determined or user-defined temporal or spatial delay.

The smallest discrete elements from non-neighboring regions are printed non-consecutively, to reduce temperature excursions and/or to reduce thermal stress, depending on the application. The order of the selection can be based on nearest other sub-segment that does not thermally interfere with the prior print. This separation can be provided as a user input or simulated or based on heuristic scaling. If the features are not separated enough, additional pause elements can be added between delivering energy to different sub-segments. This pause could be implemented as a minimum time between returning back to the same domain, or minimum time between exposing segments within a critical distance of previously exposed segments.

The laser scan jumps between printing different sub-domain segments in different domains. The order of printing the sub-segments in same domain is ideally to expose the sub-segments in a manner that relieves stress of neighboring sub-segments. One sub-segment strategy would go from inner sub-segments outward e.g., 1-2-3, as discussed below in an example of AlSi10Mg printed onto Silicon with an interlayer of SnAgTi. Another embodiment would go from an outer sub-segments inward 3-2-1. Yet another embodiment, would be to interweave, e.g., 1-3-2 or 3-1-2. For greater number of sub-segments, even more patterns can be devised, but they would in effect, prevent large shrinkage accumulations and depending on material anneal neighboring printed sub-segment stresses. These sub-segment ordering would be the order for printing the sub-segments inside a domain, though these sub-domain segments are not printed consecutively. Each domain need not have the same sub-segmentation order or number of sub-segments.

In the raster path development, optimal separation between consecutive domains can be determined by modeling, empirically, or through simple scaling. For instance, one embodiment will have a minimum consecutive domain separation distance. Another embodiment would select this distance to make the domains thermally non-interacting by separating them by some constant times the thermal penetration distance, C\sqrt{αt}, where α is the thermal diffusivity, and t is time, C is a coefficient.

The order of the domains in FIGS. 2A and 2B, remains the same between the first, second and third sub-segment rounds, but this need not be the case. The domain pattern can switch each round, and indeed it is not required that a domain feature be completed in a single round. However, time efficiency compels creating a nearly maximized cluster of pulses or raster path lengths in a set of adjacent spots to approach a thermal-related limit.

The time the galvo moves without the laser melting will lower print speeds and increase print times, so in some implementations, the segmentation strategy will be applied to small clusters of domains that are proximal, and then to other domains in the same build layer, to lower laser off repositioning time.

In one implementation, the domain and sub-domain strategy is not used, and instead segments are generated, and these segmented paths are exposed in a manner that requires minimum time between exposing segments within a critical distance of previously exposed segments.

In one embodiment of the segmentation strategy to reduce stresses can be a user selected for printing difficult to print geometries or materials. This can be applied to geometries and/or materials that may not be well suited for conventional raster processing and frequently fail.

In other implementations, the software can recognize difficult to print geometrical features using AI or computational modeling, and automatically enable this feature over difficult parts or difficult regions of parts. For instance, sharp corners, cantilevered features, overhang features, bridges could be recognized, and the software applies this method or prompts user to enable this method.

While most applications benefit from minimizing residual thermal stresses, certain applications benefit from residual stresses. In some applications, the residual stress could be tuned by modifying the sub-segmentation order or extent that neighboring sub-domains to tune residual stresses.

The process for segmenting and path planning the layer to be printed into regions of domains and sub-domains is illustrated in FIG. 2C, and the process for doing so with just domains is shown in FIG. 2D. The spatial and temporal delay can be expressed by a user, or through simulation, or by scaling relationship or through empirical means.

By scaling, for instance, the separation between neighboring exposures can be expressed as C₀(αt)^{C}^{₁}, where α is the effective thermal diffusivity, t is the time to print the segmented region, and C₀ is a coefficient on order of unity, and C₁ is a coefficient. Conservative values would be C₀ of 3.64 and C₁ of 0.5. A minimum time between exposure of neighboring regions can be solved by solving for the time, t, in

$${C}_{2} = \frac{{C}_{3}}{\sqrt{t}} exp ( - \frac{{C}_{4}}{t} ) ,$$

where C₂, C₃ and C₄ are coefficients.

This scaling comes from the cooling of 1D surface energy pulse. This critical time between neighboring exposures can be done analytically, where

$${C}_{3} = \frac{{E}^{″}}{ρC \sqrt{πα}} , and {C}_{4} = \frac{{x}^{2}}{4 α} ,$$

where E″ is the integrated energy of the laser exposure per unit area, ρ is the density, α is the effective thermal diffusivity, C is the heat capacity, and x is the distance into the substrate a thermal constraint exists. If this is done analytically, C₂ would represent a critical temperature, but if done empirically it will not be in units of temperature. It should be noted, that the effective thermal diffusivity could be different for these two, with the spatial separation equation using an effective thermal diffusivity close to the in-plane property, and the temporal separation using an effective thermal diffusivity close to the through-plane property.

Embodiments of this invention could involve various directed energy sources, including lasers, electron beams and electric arcs. With development of mirror array printers laser powder fusion printers for metals and analogous technologies possible with electron beams, thermal stresses can be reduced as described for vectorized printing technologies, but with multiple vectors combined to be exposed simultaneously. So for instance in one domain, multiple sub-segments can be first exposed A1, A3, A5, A7, . . . and then another non-neighboring domain could be exposed E1, E3, ES, E7, . . . Then after several domains being exposed once, A2, A4, A6, A8, . . . could be exposed in the second level of printing. This prior mentioned process would suit when a mirror array that can only expose a small section of the part is swept over the build volume. If the mirror array can expose the entire build plate, the exposure pattern can be broadened, so the first level printing on many domains can be done in one pass, followed by second level printing on many other domains. For instance, in the first exposure can do A1, B1, C1, D1, E1, F1, G1, G1, H1, I1 in exposure 1, followed by A3, B3, C3, D3, E3, F3, G3, G3, H3, I3 in exposure 2, followed by A2, B2, C2, D2, E2, F2, G2, G2, H2, I2. For certain applications, the process would benefit from longer pause between printing in the same domain, so a pattern like this could be adopted: A1, C1, E1, G1, G, I1 in exposure 1, followed by B1, D1, F1, H1 in exposure 2, followed by A3, C3, E3, G3, G3, I3 in exposure 3, followed by B3,D3,F3,H3 in exposure 4, followed by A2, C2, E2, G2, G2, I2 in exposure 5, followed by B2, D2, F2, H2 in exposure 6. This is just one of many permutations possible that group sub-domain elements from multiple domains simultaneously, so that thermal stress and temperature can remain below some limit. The ordering of exposures can be done with similar simulation, scaling, heuristic, or user input settings, described earlier for vectorized systems.

The present technology also applies to other additive manufacturing technologies that have shrinkage, like stereolithography (SLA). Though SLA resin curing processes typically suffer less stress than laser- and electron beam-powder bed fusion and directed energy deposition of metal, the shrinkage of the resin during cross-linking is present, and could be reduced by exposure patterns that expose multiple sub-segments from multiple domains simultaneously. The prior mirror array discussion of melting processes applies to SLA technologies in terms of potential exposure strategies.

This technique has applications to metal dropwise printing, where vectorized paths would be printed with a molten metal stream, and certain direct write technologies. However, the repositioning speed of the printhead might make implementation costlier in terms of volumetric print rate reduction relative to laser or electron beam powder bed fusion that have much faster repositioning of print location.

It is therefore an object to provide an additive manufacturing process, comprising: depositing a layer on a substrate; providing an energy source configured to direct concentrated energy on a defined portion of the layer, to cause heating, a phase transition, and a thermal stress; positioning the concentrated energy on a first portion of the layer, to cause the heating, the phase transition, and the thermal stress; repositioning the concentrated energy on a second portion of the layer distant from the first portion of the layer, to cause the heating, the phase transition, and the thermal stress; and repositioning the concentrated energy from the second portion of the layer to a third portion of the layer adjacent to the first portion of the layer, to cause the heating, the phase transition, and the thermal stress; wherein a spatial relation of the second portion to the first portion is dependent on a temperature change of the first portion during the heating of the second portion, and a thermal stress on the substrate and an interface between the substrate and the phase transitioned layer such that the repositioning from the first portion to the second portion occurs prior to exceeding a predetermined threshold temperature of the substrate and a predetermined threshold thermal stress.

It is also an object to provide an additive manufacturing process employing an energy source configured to direct concentrated energy on a defined portion of the layer, to cause heating, a phase transition, and thermal stress, comprising: depositing a layer on a substrate; and selectively heating adjacent portions of the layer on the substrate to cause the heating, the phase transition, and the thermal stress; wherein a latency between heating of the adjacent portions is selectively dependent on a peak temperature of the substrate, and a thermal stresses on the substrate.

The energy source may be a laser, or an electron beam, for example.

The layer may be formed from a powder, which is melted by the energy source or sintered by the energy source.

The substrate may comprise an integrated circuit. Integrated circuits may be electronically sensitive to both heat and strain, and therefore even if a process is mechanically feasible, it may nevertheless be incompatible with the operation of the integrated circuit. The limit on temperature and stress may be determined by measurement, modelling, scaling (i.e., extrapolation from known results), and empirically, for example. In each case, it is desired to predict the approach of the limit, i.e., peak temperature, thermal stress, and move the location of the energy beam before the limit in any region is exceeded. The accuracy of the prediction therefore should be high enough to avoid unintentional exceeding of the limit, but may be set with a margin of safety and therefore a margin for inaccuracy. For example, the prediction may have a 99.99% reliability that a true limit is not breached, but with a lower mean productivity efficiency, allowing tolerance for imprecise prediction.

The thermal stresses may be calculated dependent on material properties of the layer and the substrate.

It is also an object to provide a method for controlling thermal stress in a selective laser melting process, comprising melting neighboring regions non-consecutively, allowing sufficient time to pass between proximal melt paths to ensure that a thermally sensitive substrate does not exceed a limit temperature beyond which damage is likely.

It is a further object to provide a method for minimizing thermal stress, comprising defining adjacent melt paths, allowing sufficient time to pass between the adjacent melt paths so that a thermally sensitive substrate does not exceed a predetermined limit temperature beyond which damage is likely.

It is a still further object to provide a method for minimizing thermal stress in a selective melting additive manufacturing process on a thermally sensitive substrate, comprising constructing a set of slices as concentric melt pool paths outward from a perimeter, allowing sufficient time to pass between proximal slices so the thermally sensitive substrate does not exceed a threshold temperature beyond which damage is likely.

It is also an object to provide a selective melting additive manufacturing method, comprising: defining a series of segments, to be selectively melted to form a layer on a substrate; and checking each segment to maximize a thermal overlap, defined in terms of a minimum time to melt different melt pool distances away from prior melted segments.

The method may further consider if any segment has a sufficient thermal separation, and then waiting until the thermal separation meets a criterion.

The method may further comprise planning a timing of the selective melting of respective segments wherein with Multiphysics simulations that impose criteria based not exceeding maximum temperature, thermal gradients, and stresses.

The method may further comprise measuring an in situ temperature, and selectively dependent thereon imposing a pause before heating a respective segment if a temperature adjacent to the segment exceeds a threshold.

Process constraints may be determined empirically based on properties of the layer and properties of the substrate and/or geometry of the prior melted segments.

It is another object to provide an additive manufacturing process employing an energy source for directing concentrated energy toward a layer on a substrate, the energy source being adapted to cause localized heating of a portion of the layer, a phase change of the portion of the layer, and a residual stress proximal to an interface between the substrate and the portion of the phase transitioned layer, the method comprising: positioning the concentrated energy in a first series of adjacent positions in a first region of the substrate, to cause the localized heating of the first region, the phase transition, and the residual stress proximal to the interface between the substrate and the first portion of the phase transitioned layer, under conditions which are predicted to meet a temperature criterion and a stress criterion of the first region; repositioning the concentrated energy in a second series of adjacent positions in a second region of the substrate sufficiently distant from the first region such that the first region cools while the second portion is being heated, to cause the localized heating of the second region, the phase transition, and the residual stress proximal to the interface between the substrate and the second portion of the phase transitioned layer, under conditions which are predicted to meet a temperature criterion and a stress criterion of the second region; and repositioning the concentrated energy in a third series of adjacent positions in the first region of the substrate after the cooling of the first region, to cause the heating of the first region, the phase transition, and the residual stress proximal to the interface between the substrate and the first portion of the phase transitioned layer, under conditions which are predicted to meet the temperature criterion and the stress criterion of the first region, while allowing a cooling of the second region.

Another object provides an additive manufacturing process, comprising: depositing a layer on a substrate; providing an energy source configured to direct concentrated energy on a defined portion of the layer, to cause heating, a phase transition, and a thermal stress; positioning the concentrated energy on a first portion of the layer, to cause the heating, the phase transition, and the thermal stress; repositioning the concentrated energy on a second portion of the layer distant from the first portion of the layer, to cause the heating, the phase transition, and the thermal stress; and repositioning the concentrated energy from the second portion of the layer to a third portion of the layer adjacent to the first portion of the layer, to cause the heating, the phase transition, and the thermal stress; wherein a spatial relation of the second portion to the first portion relies on separation of critical distance determined through at least one of modeling, scaling, or empirical determination of a stress on the substrate and an interface between the substrate and the phase transitioned layer.

A further object provides an additive manufacturing process, comprising: depositing a layer on a substrate; providing an energy source configured to direct concentrated energy on a defined portion of the layer, to cause heating, a phase transition, and a thermal stress; positioning the concentrated energy on a first portion of the layer, to cause the heating, the phase transition, and the thermal stress; repositioning the concentrated energy on a second portion of the layer distant from the first portion of the layer, to cause the heating, the phase transition, and the thermal stress; and repositioning the concentrated energy from the second portion of the layer to a third portion of the layer adjacent to the first portion of the layer, to cause the heating, the phase transition, and the thermal stress; wherein a temporal relation of the second portion to the first portion exceeds a time period determined through modeling, scaling, or empirical analysis.

A still further object provides an additive manufacturing process employing an energy source for directing concentrated energy toward a layer on a substrate, the energy source being adapted to localize heating of a portion of the layer, a phase change of the portion of the layer, and a residual stress proximal to an interface between the substrate and the portion of the phase transitioned layer, the method comprising: positioning the concentrated energy in a first series of adjacent positions in a first region of the substrate, to cause the localized heating of the first region, the phase transition, and the residual stress proximal to the interface between the substrate and the first portion of the phase transitioned layer, under conditions which are predicted to meet a temperature criterion and a stress criterion of the first region, thereby additively manufacturing a portion of a first feature, and wherein a continuous additive manufacturing of the entire feature is predicted to exceed at least one of the temperature criterion and the stress criterion of the first region; before exceeding at least one of the temperature criterion and the stress criterion of the first region, repositioning the concentrated energy in a second series of adjacent positions in a second region of the substrate, to cause the localized heating of the second region, the phase transition, and the residual stress proximal to the interface between the substrate and the second portion of the phase transitioned layer, under conditions which are predicted to meet a temperature criterion and a stress criterion of the second region, thereby additively manufacturing a portion of a second feature, and wherein a continuous additive manufacturing of the entire second feature is predicted to exceed at least one of the temperature criterion and the stress criterion of the second region; and after the first region has cooled, completing additively manufacturing a portion of a first feature, without exceeding the temperature criterion and the stress criterion of the first region.

An object also provides an additive manufacturing process employing an energy source for directing concentrated energy toward a layer on a substrate, the energy source being adapted to localize heating of a portion of the layer, a phase change of the portion of the layer, and a residual stress proximal to an interface between the substrate and the portion of the phase transitioned layer, the method comprising: positioning the concentrated energy in a first series of adjacent positions in a first region of the substrate, to cause the localized heating of the first region, the phase transition, and the residual stress proximal to the interface between the substrate and the first portion of the phase transitioned layer, under conditions which are predicted to meet a temperature criterion and a stress criterion of the first region, thereby additively manufacturing a portion of a first feature, and wherein a continuous additive manufacturing of the entire feature is predicted to exceed at least one of the temperature criterion and the stress criterion of the first region; before exceeding at least one of the temperature criterion and the stress criterion of the first region, repositioning the concentrated energy in a second series of adjacent positions in a second region of the substrate, to cause the localized heating of the second region, the phase transition, and the residual stress proximal to the interface between the substrate and the second portion of the phase transitioned layer, under conditions which are predicted to meet a temperature criterion and a stress criterion of the second region, thereby additively manufacturing a portion of a second feature, and wherein a continuous additive manufacturing of the entire second feature is predicted to exceed at least one of the temperature criterion and the stress criterion of the second region; and after the first region has cooled, completing additively manufacturing a portion of a first feature, without exceeding the temperature criterion and the stress criterion of the first region.

Another object provides an additive manufacturing process which uses localized energy to sinter a powder into a pattern of vertical structures with gaps on a substrate, the method comprising: forming a first portion of a first vertical structure with a series of adjacent energy pulses which sinter the powder and induce thermal stress; repositioning the series of adjacent energy pulses prior to completing additive manufacturing of the first vertical structure before exceeding a maximum thermal stress, to form a second portion of a second vertical structure and while allowing the first vertical structure to cool; and repositioning the series of adjacent energy pulses prior to completing additive manufacturing of the second vertical structure before exceeding the maximum thermal stress, to form a third portion of the first vertical structure and while allowing the second vertical structure to cool; wherein a distance of repositioning between the first structure and the second structure corresponds to a repositioning latency, and wherein the amount of the first structure represented by the first portion and the third portion, and the latency between deposition of the first portion and the third portion are together optimized to form the pattern of vertical structures in a minimum time without exceeding the maximum thermal stress.

A further object provides an additive manufacturing control system, comprising: an input port configured to receive a manufactured product configuration; an automated control configured to receive the manufactured product configuration, and to define a manufacturing process comprising deposition of at least one layer on a substrate having a boundary, wherein the deposition comprises sintering of a powder, and the sintering is associated with a heating of the substrate proximate to the sintering and an associated thermal stress, the manufacturing process comprising: defining a series of adjacent locations for sintering, to build a portion of the layer; predicting a limit based on at least one of a peak temperature of the substrate and a thermal stress at an interface of the substrate and the layer; inserting a discontinuity of the defined series of adjacent locations for sintering before the predicted limit is reached, such that a previously sintered region is allowed to cool and a subsequent series of adjacent locations for sintering builds a different portion of the layer, the subsequent series of adjacent locations being displaced from the series of adjacent locations by a physical distance sufficient that the heating of the substrate proximate to the subsequent series of adjacent locations does not prevent the cooling of the substrate proximate to the series of adjacent locations; and returning to sinter proximate to the defined series of adjacent locations after cooling has occurred, wherein the amount of the defined series of adjacent locations, the timing of the inserted discontinuity, the amount of the subsequent defined series of adjacent locations, and the displacement of the defined series of adjacent locations from the subsequent defined series of adjacent locations, are optimized to minimize a manufacturing duration; and an output port configured to deliver control signals for an additive manufacturing system.

It is another object to provide an additive manufacturing process, comprising: depositing a layer on a substrate; providing an energy source configured to direct concentrated energy on a defined portion of the layer, to cause heating, a phase transition, and a thermal stress; and positioning the concentrated energy on a first portion of the layer, to cause the heating, the phase transition, and the thermal stress; wherein the process latency between proximal regions to ensure sufficient temperature and thermal stress conditions are defined by a minimum separation between exposure regions.

A further object provides a method of additive manufacturing, comprising: depositing a fusible powder on a surface; directing concentrated energy at a first portion of the powder to heat the first portion of the powder to fusion, heat the substrate under the fused first portion of the powder, and induce a first thermal stress; directing concentrated energy at a second portion of the powder to heat the second portion of the powder to fusion, heat the substrate under the fused second portion of the powder, and induce a second thermal stress; the heating of second portion being adjacent to and temporally proximate to the heating of the first portion; predicting an accumulation of first thermal stress and the second thermal stress, e.g., to exceed a thermal stress threshold; upon prediction of exceeding the thermal stress threshold, directing concentrated energy at a third portion of the powder to heat the third portion of the powder to fusion, heat the substrate under the fused third portion of the powder, and induce a third thermal stress; the heating of third portion being spatially distant from the first portion and the second portion such that the third thermal stress does not accumulate with the first thermal stress and the second thermal stress; and upon relaxation of the accumulated first thermal stress and the second thermal stress, to a level below the thermal stress threshold, directing concentrated energy at a fourth portion of the powder to heat the fourth portion of the powder to fusion, heat the substrate under the fused fourth portion of the powder, and induce a fourth thermal stress.

It is another object to provide a manufacturing method for selectively heating portions of defined portions of a surface of a substrate with an energy source configured to direct concentrated energy on a defined portion of the surface of the substrate, to cause heating and thermal stress in the defined portions, the method comprising: exposing a first portion of the surface of the substrate to the concentrated energy to cause the heating and the thermal stress proximate to the first portion; and exposing a second portion of the surface of the substrate adjacent to the first portion to the concentrated energy to cause the heating and the thermal stress proximate to the second portion, wherein a latency between heating of the first portion and before heating the adjacent second portion is selectively dependent on a peak temperature of the substrate, and a thermal stress proximate to the first portion.

During the latency, a third portion of the surface of the substrate which is not adjacent to the first portion and is not adjacent to the second portion may be exposed to the concentrated energy to cause the heating and the thermal stress proximate to the third portion.

A spatial relation of the third portion to the first portion may be dependent on at least a temperature change of the first portion during the heating of the third portion of the layer, and a thermal stress on the substrate.

A repositioning of the concentrated energy from the first portion to the third portion may occur prior to the first portion exceeding a predetermined threshold temperature and exceeding a predetermined threshold thermal stress in the first portion.

The concentrated energy may cause a phase transition in the defined portion.

The manufacturing method may further comprise depositing a layer on a substrate before exposing the first portion. The deposited layer may comprise a meltable, fusible or sinterable powder, and the concentrated energy is adapted to cause melting, fusion or sintering of the powder.

The energy source may comprise at least one of a laser and an electron beam.

The substrate may comprise an integrated circuit.

The peak temperature of the substrate, and the thermal stress proximate to the first portion are calculated by an automated control dependent on material properties of the layer and the substrate.

It is another object to provide a material processing manufacturing method, comprising: defining a series of segments for treatment, each segment representing a region to be selectively heated to process a layer on a surface of a substrate; and automatically checking each successive segment to control a thermal overlap with prior heated segments, wherein: if a temperature or thermal stress would exceed a threshold as a result of the heating of the respective segment, a spatially distant segment is selected as the next successive segment of the series of segments, and if the temperature or thermal stress would not exceed the threshold as a result of the heating of the respective segment, a spatially proximate segment is selected as the next successive segment of the series of segments.

The method may further comprise planning a sequence and timing of the selective heating of respective segments with Multiphysics simulations that impose criteria to assure that the defined series of segments does not exceed a maximum temperature, maximum thermal gradient, and a maximum stress.

A repositioning of the heating between successive segments may incur a distance-related latency, and the sequence and timing of the selective heating may be planned to minimize a material processing duration.

The method may further comprise measuring an in situ temperature, and selectively dependent on the measured in situ temperature, imposing a pause before heating a respective segment if a temperature adjacent to the segment exceeds a threshold.

Process constraints may be determined empirically based on properties of the layer and properties of the substrate.

Process constraints may be determined empirically based on properties of the layer and geometry of the prior melted segments.

The material processing may comprise an additive manufacturing process, and the selective heating melts, fuses or sinters particles deposited on the surface of the substrate to form the layer.

It is a further object to provide an automated controller for controlling an additive manufacturing process employing an energy source for directing concentrated energy toward a layer on a substrate, the energy source being adapted to cause localized heating of a portion of the layer, a phase change of the portion of the layer, and a residual stress proximal to an interface between the substrate and the portion of the phase transitioned layer, the automated controller executing non-transitory instructions to:
position the concentrated energy in a first series of adjacent positions in a first region of the substrate, to cause the localized heating of the first region, the phase transition, and the residual stress proximal to the interface between the substrate and the first portion of the phase transitioned layer, under conditions which are predicted to approach but not exceed a threshold temperature criterion and a stress criterion of the first region, wherein additional localized heating would exceed the threshold temperature criterion;
reposition the concentrated energy in a second series of adjacent positions in a second region of the substrate sufficiently distant from the first region such that the first region cools while the second portion is being heated, to cause the localized heating of the second region, the phase transition, and the residual stress proximal to the interface between the substrate and the second portion of the phase transitioned layer; and
reposition the concentrated energy in a third series of adjacent positions in the first region of the substrate after the cooling of the first region, to cause the heating of the first region, the phase transition, and the residual stress proximal to the interface between the substrate and the first portion of the phase transitioned layer, under conditions which are predicted to approach but not exceed the threshold temperature criterion and the stress criterion of the first region, while the second region cools.

The non-transitory instructions may comprise instructions for planning a sequence and timing of the concentrated energy with Multiphysics simulations that impose criteria to assure that the defined series of segments does not exceed a maximum temperature, maximum thermal gradient, and a maximum stress.

The non-transitory instructions may comprise instructions for automatically checking a thermal overlap between a respective position and prior heated positions.

Another object provides a method of controlling a selective sintering additive manufacturing process, comprising cumulating a power of a first rapid series of adjacent energy pulses in a first region, having an energy pulse rate fast with respect to a thermal diffusion of heat from the first region, to conservatively predict a first peak temperature in the first region, and ceasing the first rapid series of adjacent energy pulses in the first region based on the predicted first peak temperature; locating a second region at a sufficiently distance from the first region such that the second region is substantially thermally decoupled from the first region; cumulating a power of a second rapid series of adjacent energy pulses in the second region, having an energy pulse rate fast with respect to a thermal diffusion of heat from the second region, to conservatively predict a second peak temperature in the second region, and ceasing the second rapid series of adjacent energy pulses in the second region based on the predicted second peak temperature; and after cooling of the first region, cumulating a power of a third rapid series of adjacent energy pulses in a third region adjacent to the first region, wherein the first region and the third region are part of a common structure.

A further object provides a method of controlling a selective sintering additive manufacturing process, comprising: receiving geometry file for additive manufacturing; segmenting the file into a plurality of spatially separated domains; for each domain, applying a domain shape basis set and a domain maximum size; defining an ordered set of energy pulses corresponding to the applied domain shape basis set constrained to the domain maximum size for additive manufacturing of a layer corresponding to the geometry file; and defining a minimum spatial and temporal separation of the ordered set of energy pulses corresponding to the applied domain shape basis set and a subsequent set of energy pulses adjacent to the domain. The ordered set of energy pulses may be output by an additive manufacturing system to fabricate or form the layer according to the geometry file.

The defined ordered set of energy pulses may be output to an additive manufacturing system for forming the layer corresponding to the geometry file.

The method may further comprise outputting the defined subsequent set of energy pulses adjacent to the domain after the minimum temporal separation, wherein intervening energy pulses between the defined ordered set of energy pulses and the defined subsequent set of energy pulses are displaced by at least the minimum spatial separation from the defined ordered set of energy pulses.

The exceeding of the limit may be determined empirically, through a sensor (stress or temperature). In some cases, a conservative rule is implemented that does not require measuring or calculating thermal stress, and rather avoids empirically exceeding a functional limit through a range of operating conditions.

Typically, the operation of the additive manufacturing process operates faster than it is feasible (using present technologies having a scale appropriate for this application) to perform real-time digital calculations for calculating thermal stresses in the structure under manufacture. Further, it is preferred that the manufacturing process be predetermined, rather than unpredictable. Therefore, a general strategy is to define heuristics that ensure that the thermal excursions and resulting stresses remain sufficiently limited to ensure that the resulting device is functional. For example, while reliably limiting peak temperature to 90-95% of permissible peak temperature may be quite difficult, especially if no sensors are employed, limiting the peak temperature to 60-85% of permissible peak temperature may be easier. This temperature range may be more readily estimated based on heuristics or simple rules, rather than measured characteristics.

Therefore, a simple paradigm may be employed, which defines a series of adjacent fusions, which accumulate heat over a period of time, and after a power limit for a small area is reached, the fusions are displaced a sufficient distance from the initial fusions such that the thermal coupling of the two regions is small, and a new series of adjacent fusions is commenced. Therefore, one available heuristic is to treat the fusions as occurring at the same point and without thermal diffusion, so that the power of each pulse may be simply summed, which then permits overestimation of the maximum temperature. The distance between regions may be determined by treating the cumulative power at each region as an impulse, with a single thermal diffusion equation (or approximation thereof) employed to consider their interaction.

In this manner, a safe (conservative) regime of operation may be ensured, with low computational complexity, permitting advance computation of the (maximum) number of adjacent pulses, and the (minimum) distance between sets of pulses. Of course, in a complete structure, there will be a number of sets of adjacent pulses, so that the thermal interactions of the sets may become complex.

### BRIEF DESCRIPTION OF THE DRAWINGS

FIGS. 1A-1F show different laser scanning strategies available in the literature.

FIGS. 2A and 2B show an example of proposed laser scanning strategy.

FIGS. 2C and 2D show flowcharts of operation of the method.

FIGS. 3A-3E show photographs of a masked module with an integrated circuit, upon which is deposited a heatsink by selective laser sintering.

FIGS. 3F and 3G show a photograph of a module with an integrated circuit, upon which is deposited a heatsink by selective laser sintering (FIG. 3F), and an enlarged view of the processor with heatsink (FIG. 3G).

FIG. 4A shows the design as 25 rows of concentric shells on a 10 mm×10 mm square integrated circuit with 78.5% coverage.

FIG. 4B shows the layout of the concentric shells with a center-to-center distance of 400 μm.

FIG. 5A and FIG. 5B show enlarged views of each set of shells.

FIGS. 6A-6D show photographs and optical profiles of the integrated circuit package before and after deposition of the heatsink.

FIGS. 6E-6F show warpage measurement on an Nvidia® Jetson Nano™ package with plain die in addition to the package with printed micro-bumps.

FIGS. 7A and 7B compare a default skin and contour exposure with the segmented exposure according to the present invention;

FIG. 8A shows that the power of each row was varied from 129 W to 333 W to find the optimize value.

FIG. 8B shows that the printed pins were successful for all the segmentation tested exposure laser powers, except last three rows that used 129-159 W.

FIGS. 9A and 9B show results of shear testing of the pin fins printed onto silicon.

FIGS. 10A and 10B show a comparison between the shear strength of pin fins printed with and without segmentation exposure strategy.

FIG. 11 shows a schematic of the mechanical model of printing pin fin onto silicon using Sn3Ag4Ti interlayer alloy.

FIGS. 12A to 12C show the interfacial shear stresses during 20° C. of temperature decrease at the silicon-interlayer alloy interface based on the pin fin diameter made with conventional rastering in one step.

FIG. 13 shows the interfacial shear stress as a function of temperature cool down for an AlSi10Mg pin fin with a diameter of 700 μm printed onto Si substrate with Sn3Ag4Ti interlayer alloy made with conventional rastering in one step.

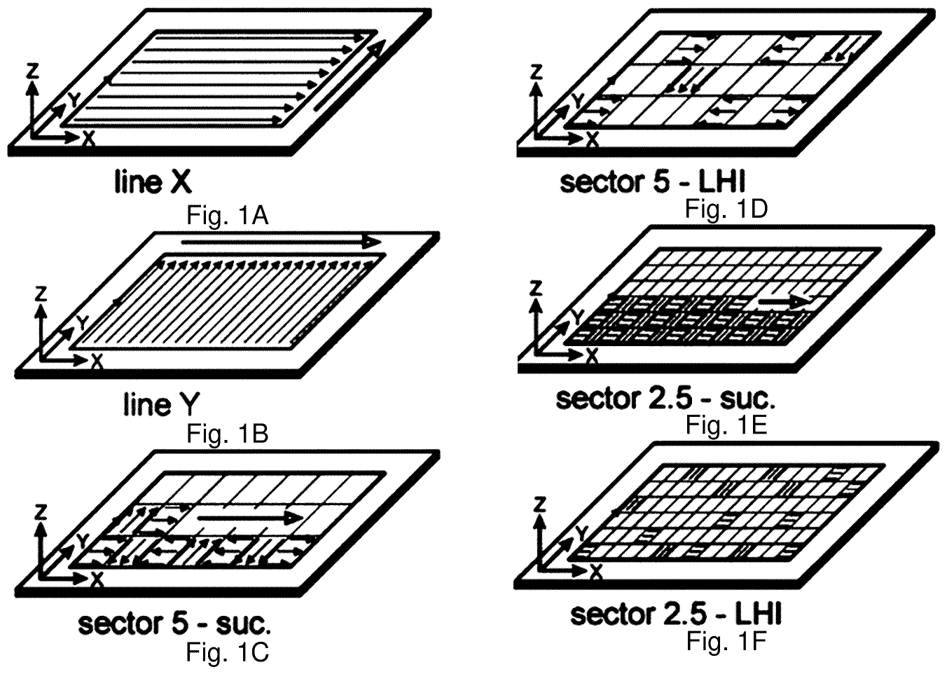

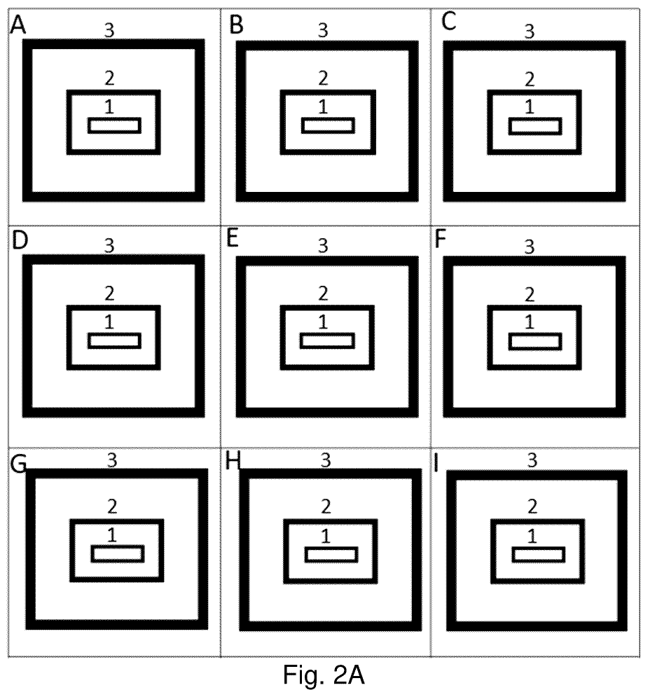

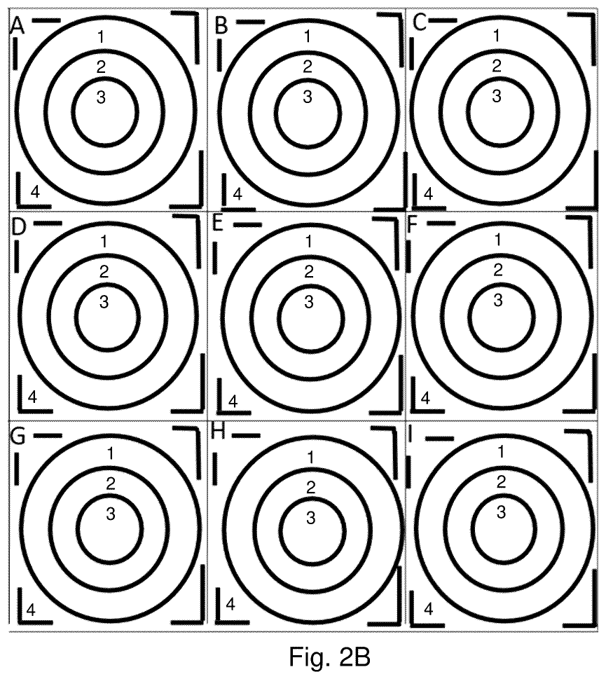

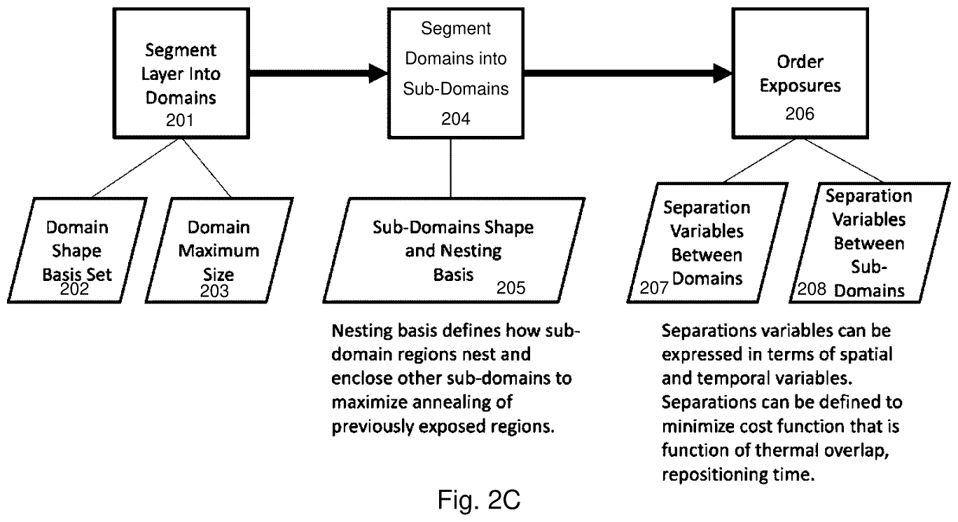

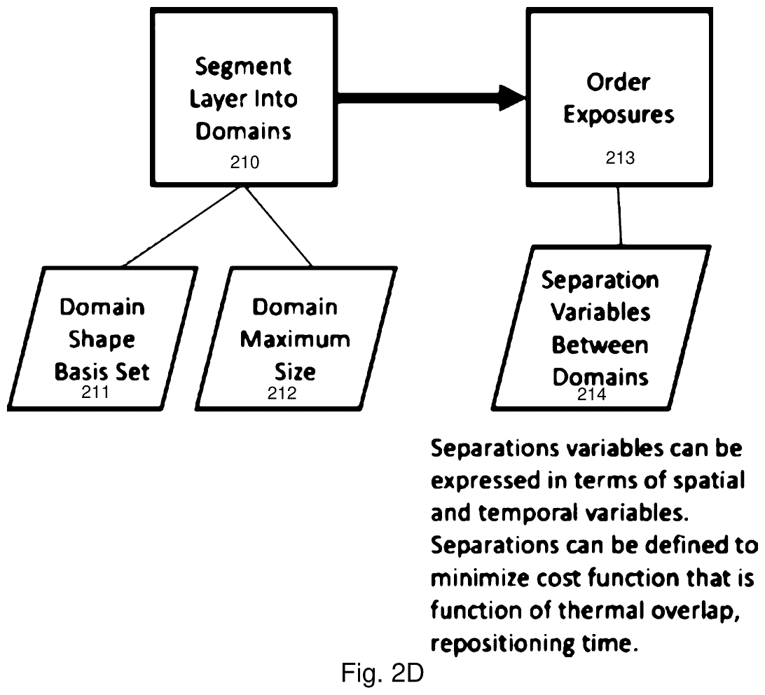

### DETAILED DESCRIPTION OF THE PREFERRED EMBODIMENTS

### Example 1

Sn₃Ag₄Ti, a low melt alloy, bonds to silicon via titanium silicide formation at the interface during selective laser melting [1,2,15]. Deposition of this material onto silicon chip over a large coverage area with common scanning patterns such as alternating lines damages the chip/electronic package. The damage can be in the form of microscopic internal cracks in the silicon, damage to the transistors or breaking of the electrical connections such as interconnects between the silicon and the electronic substrate. This damage is due to coefficient of thermal expansion mismatch between silicon and Sn₃Ag₄Ti and localized heat buildup. This example shows how segmentation scanning strategy can be implemented to avoid such damage and minimize thermal stresses during the print process.

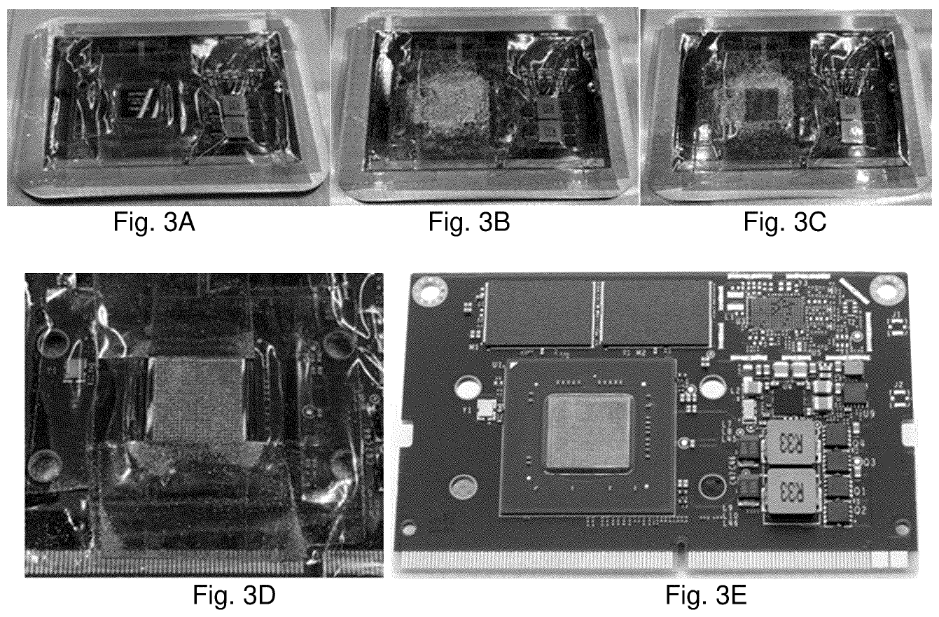

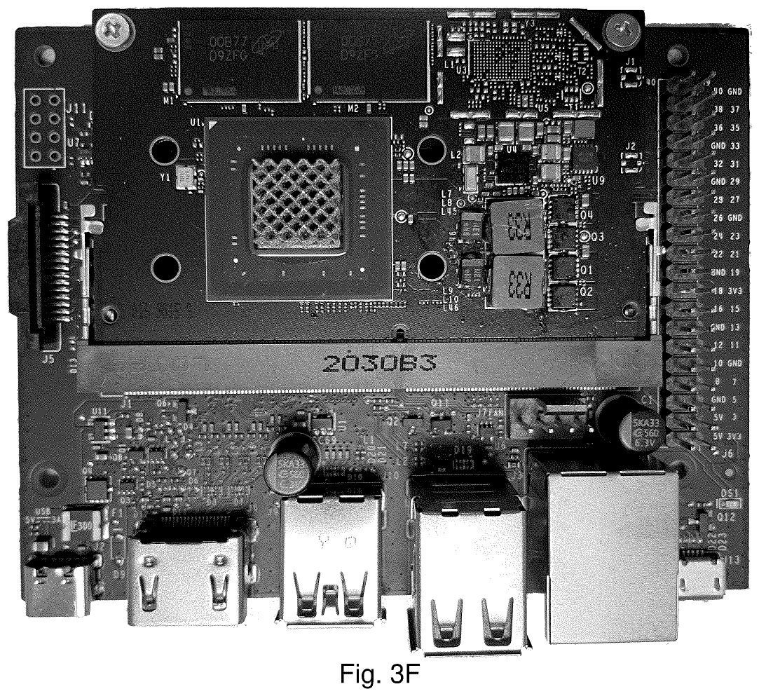

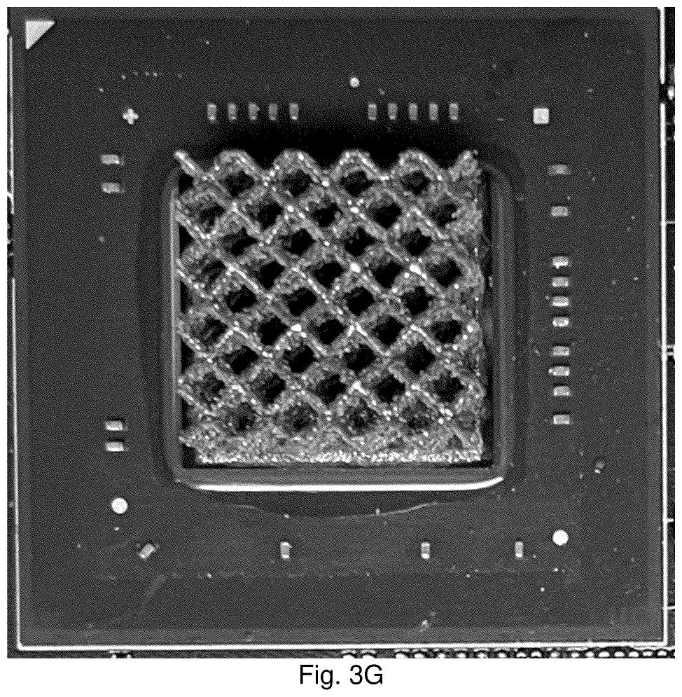

An Nvidia® Jetson Nano™ package was used as testbed for the experiment. The default heat sink and thermal interface material was removed from the chip, revealing the silicon die. The package with the die was removed from the motherboard. The package was inserted into an EOS M290 laser powder bed fusion system with custom-made package holder. The entire package except the die was covered with Kapton® Polyimide tape to prevent electrical short circuit (FIG. 3A). The experiment was performed in an argon protective environment with oxygen concertation of less than 0.1%. A 120 μm of flat-shaped Sn₃Ag₄Ti powder, processed by ball milling, was deposited on the die with high packing density (FIG. 3B). The unfused powder is partially removed to reveal the formed features (FIG. 3C), and completely removed to show the micro array of heat sink vertically extending structures. The Kapton tape is removed to reveal the finished modified board (FIG. 3E).

FIG. 3F shows another embodiment of a computing module with an exposed integrated circuit, on which a heatsink is deposited by selective laser sintering. FIG. 3G shows an enlarged view of the processor itself, with heatsink in a rectangular pattern (+45°,−45°).

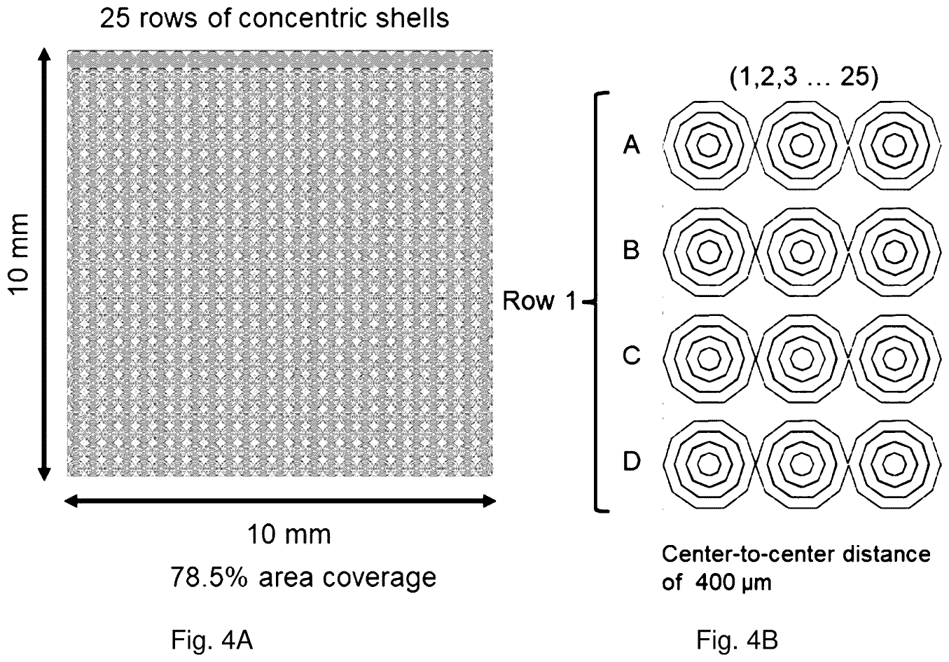

A laser power of 120 W, laser scanning speed of 3300 mm/s was used for contour/edge double exposure (based on EOSPRINT V 1.8 software terminology). The die area of 10×10 mm was considered for the print process (FIG. 4A). Micro-bumps with a diameter of 400 μm and center-to-center distance of 400 μm in both X and Y directions were to be printed on the die (FIG. 4B, showing 3 columns and 4 rows of a larger 25 by 25 array).

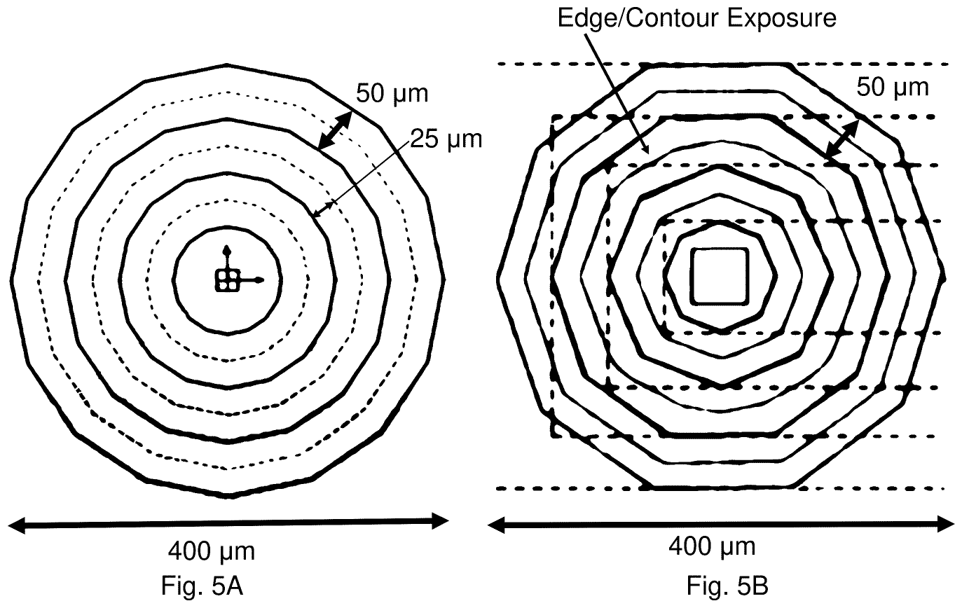

The circular micro-bumps were split into four concentric shells with 50 μm widths (outer radii to inner radii widths) based on the optimized melt pool width of the Sn₃Ag₄Ti alloy (FIGS. 5A and 5B). Shells of each row were combined together as a single part in the Materialize Magics software V 19.01 to reduce the total number of parts and force the printer software to scan each shell during the print based on the desired sequence (FIG. 4B). In this strategy, the 25 bumps in the first row converted into 4 parts, where each part consists of 25 shells (FIG. 4A).

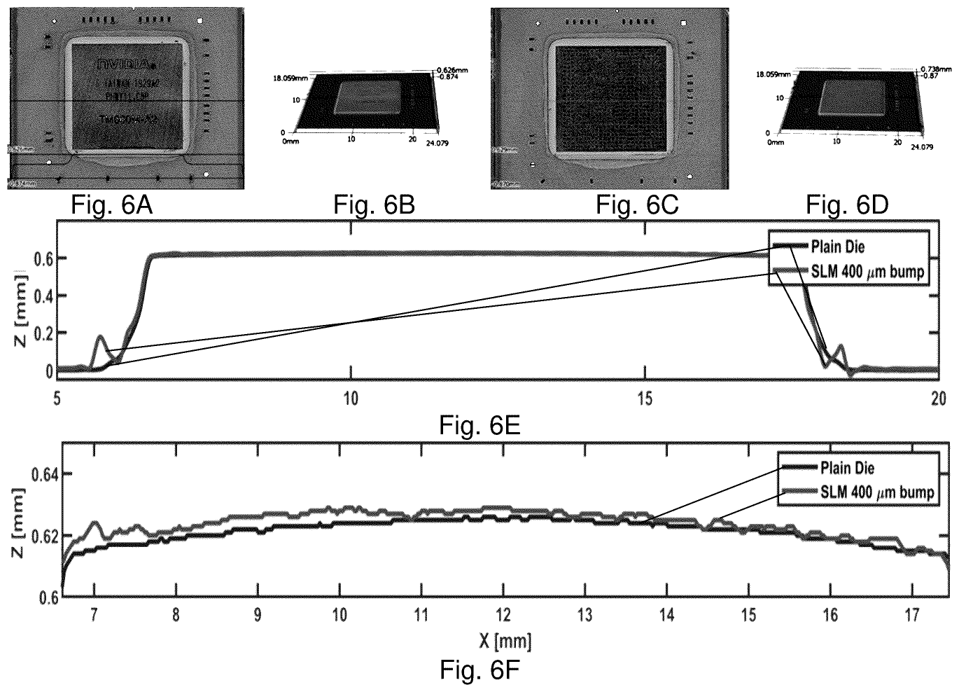

The exposure strategy was organized to scan the outer shell first, then print a dummy part with low power outside of the print area after finishing the first shell group to artificially create a delay, and then print the remaining inner shell groups based on the programmed order (FIG. 4B). After scanning the entire parts in the first row, the program continued same process with the next 24 rows (FIG. 4A). With this design, a die area coverage of 78.5% is achieved. After the print, the remaining powder is cleaning from the package. The chip was successfully booted with full functionality. Warpage measurement was performed on an Nvidia® Jetson Nano™ package with plain die (FIGS. 6A and 6B) in addition to the package with printed micro-bumps (FIGS. 6C-6D). Keyence VR-3100 optical profilometer was used for the measurement. The results show minimal warpage change (<6 μm) between the plain die (FIG. 6E) and the die with selective laser melted micro-bumps (FIG. 6F). The warpage difference between the printed case and control has uncertainty due to roughness of the printed layer, so this is the upper limit of the warpage difference. The warpage of the control die was approximately 13 μm.

### Example 2

High conductivity metals such as aluminum alloys and copper are attractive for additive fabrication of heat removal devices such as heat sinks, cold plates and boiling enhancement coatings. However, such materials cannot be directly printed onto a semiconductor substrate due to mismatch in coefficient of thermal expansion in addition to poor wetting behavior. A low melt interlayer alloy such as Sn₃Ag₄Ti can be employed to improve bond properties, wettability and reduce the effect of coefficient of thermal expansion mismatch. Details of this process are disclosed in previous patent applications [1,2]. The laser exposure strategy can be employed to further reduce the effect of thermal stresses and improve interfacial bond strength.

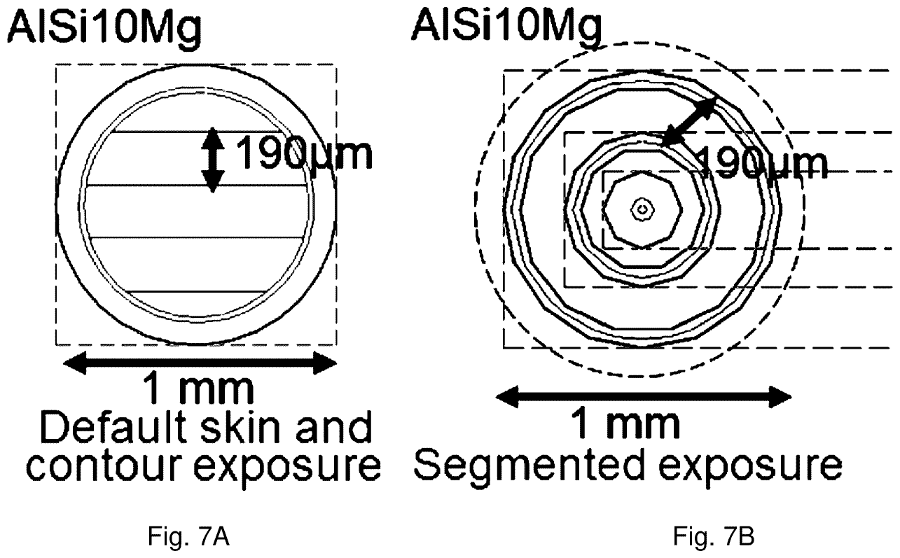

A 4-inch silicon wafer was used a substrate to print AlSi10Mg pin-fins onto it by selective laser melting. An EOS M290 laser powder bed fusion system was used for the selective laser melting experiment. The silicon wafer was installed in the printed by a custom-made sample holder and secured using polyimide tape. All experiments were performed under argon atmosphere with oxygen concentration of less than 0.1%. In an experiment, a single layer of custom-made ball milled Sn3Ag4Ti powder with the thickness of 120 μm was deposited manually onto the silicon wafer. Circular pads with the diameter of 1 mm were selective laser melted onto the silicon substrate with a laser power of 120 W, laser scanning speed of 3300 mm/s, hatch distance of 50 μm with skin strategy based on EOSPRINT V 1.8 software terminology. Double laser exposure with an angle of 90 degrees rotation was used for selective laser melting. After printing of the Sn3Ag4Ti interlayer, the powder is switched to AlSi10Mg with the layer thickness of 30 μm, and pin fins with the diameter of 1 mm were printed onto the Sn3Ag4Ti interlayer with the default skin and contour laser exposure parameters (FIG. 7A). This sample is termed the control or non-segmented sample.

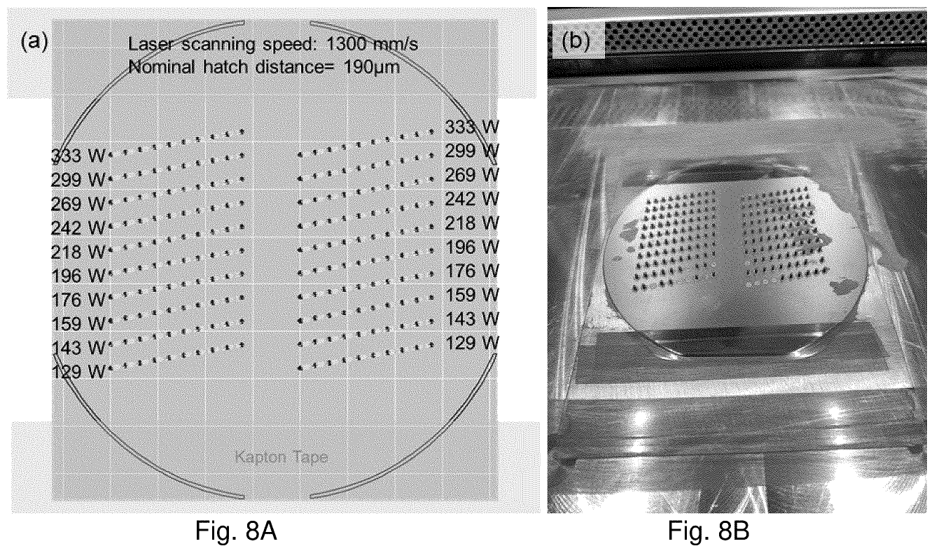

Next, a sample with identical dimensions and layers was printed but using a segmented print path. Sn3Ag4Ti pads with the diameter of 1 mm were selective laser melted onto a 4-inch silicon wafer with the same segmentation strategy as example 1. After printing of the Sn3Ag4Ti pads, the powder is switched to AlSi10Mg and pin fins with the diameter of 1 mm were printed using segmentation strategy (FIG. 7B). For this process, 3 concentric shells with the width of 50 μm and line-to-line distance of 190 μm based on the optimized melt pool size for AlSi10Mg were designed. Edge exposure was used for the two outer shells and contour exposure was used for the core shell. Laser scanning speed of 1300 mm/s and layer thickness of 30 μm was used for all exposures. The shells in each row were combined as a single part to force the software to exposure each shell based on the desired sequence similar to Example 1. The power of each row was varied from 129 W to 333 W to find the optimize value (FIG. 8A). The printed pins were successful for all the segmentation tested exposure laser powers, except last three rows that used 129-159 W (FIG. 8B).

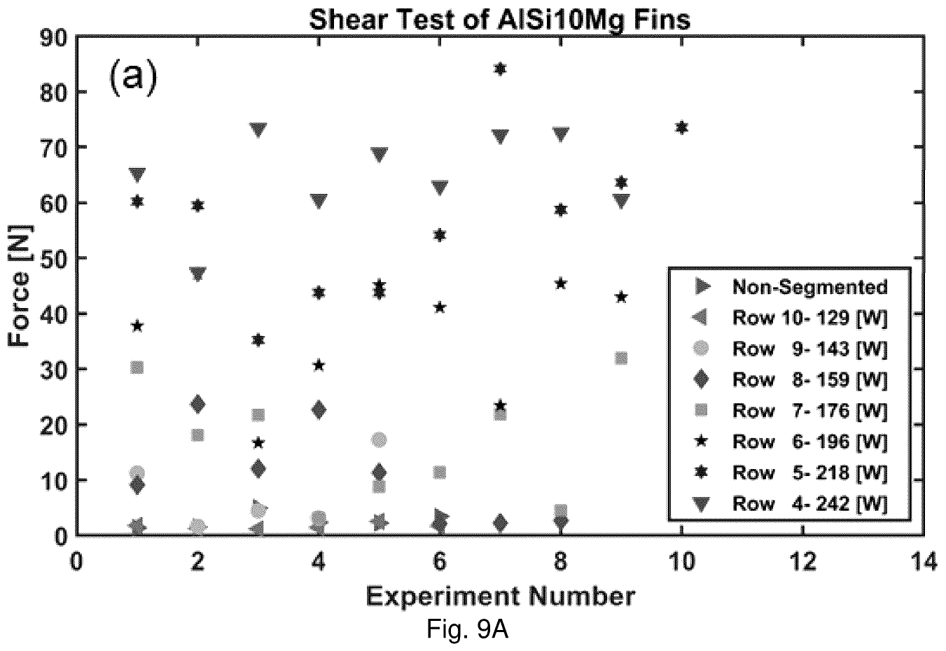

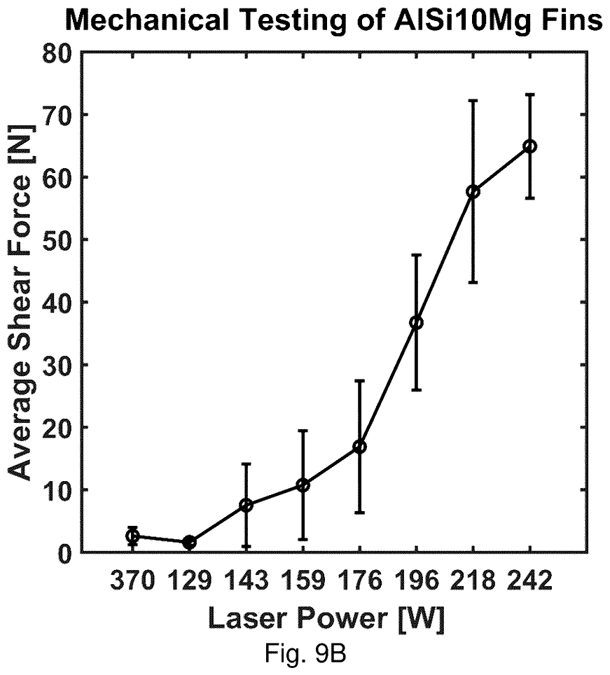

Samples fabricated in both experiments were mechanically tested by applying a shear force with the shear height of 15 μm with a Nordson Dage 4000+Bond Tester. The results of this tests indicate that the AlSi10Mg pin fins printed with segmentation strategy could resist considerably higher shear force (FIG. 9A). The average shear force was improved from 0.26 kgf in the non-segmented sample to 6.49 kgf with segmentation strategy with optimized laser power (FIG. 9B).

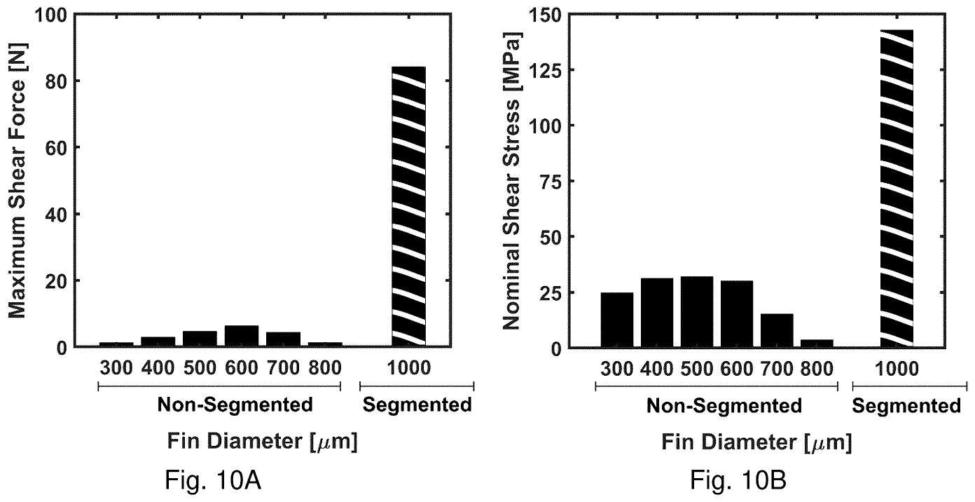

FIGS. 10A and 10B show a comparison between the shear strength of pin fins printed with and without segmentation exposure strategy. The non-segmented fabrication strategy according to FIG. 10A shows a lower maximum shear force than the segmented fabrication strategy according to FIG. 10B.

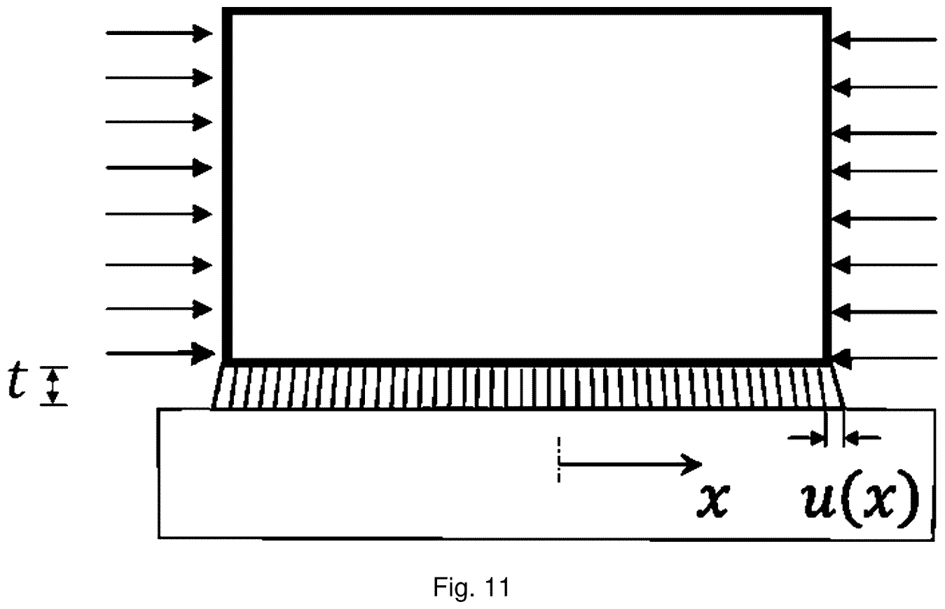

To demonstrate the effect of pin diameter on interfacial strength, AlSi10Mg pin fins were printed onto silicon wafer using the Sn3Ag4Ti interlayer similar to the previous experiment but with non-segmented exposure parameters. Pin diameters of 300 μm, to 800 μm with increments of 100 μm were printed onto the silicon substrate. It was observed that the maximum interfacial shear strength first increased with increasing pin diameter, but then decreased as the pin diameter exceeded a critical diameter (˜600 μm) (FIG. 11). This is due to crack initiation in silicon as a result of large thermal stresses at the silicon-interlayer alloy interface.

A theoretical mechanics model is developed to estimate the maximum stress on the silicon substrate during printing of metal fins. Mismatch in shrinkage of aluminum pins and silicon substrate during the temperature decrease due to difference in coefficient of thermal expansion is given by (FIG. 11)

u(x)=(α_{AlSi10Mg}−α_{Si})·ΔT·x

where x is the coordinate axis with x=0 at the substrate's center, u(x) is the shrinkage mismatch due to the temperature decrease, α_{Al} is the thermal expansion coefficient of AlSi10Mg pin fin, α_{Si} is the thermal expansion coefficient of silicon substrate, ΔT is temperature difference between the layers at formation of the SnAgTi bond.

Shear stress at the interface before and after Sn3Ag4Ti alloy yielding is given by

$$τ = \{ \begin{matrix}\frac{u ( x )}{t} \cdot {G}_{Sn 3 Ag 4 Ti} , \frac{u ( x )}{t} \cdot {G}_{Sn 3 Ag 4 Ti} \leq {τ}_{Sn 3 Ag 4 Ti}^{Y} \\ {τ}_{Sn 3 Ag 4 Ti}^{Y} , \frac{u ( x )}{t} \cdot {G}_{Sn 3 Ag 4 Ti} > {τ}_{Sn 3 Ag 4 Ti}^{Y}\end{matrix}$$

where t is the thickness of the Sn3Ag4Ti interlayer, τ is interfacial shear stress, G_{Sn3Ag4Ti} is the shear modulus of the Sn3Ag4Ti alloy, τ_{Sn3Ag4Ti}^{Y} is yielding shear stress of the interlayer alloy.

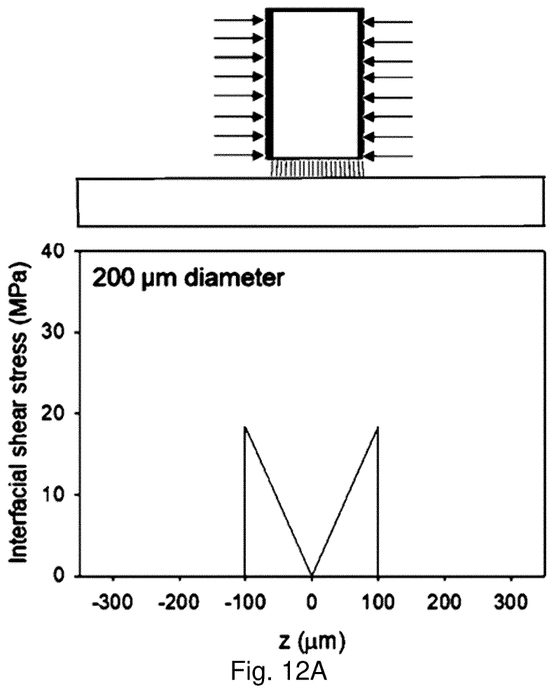

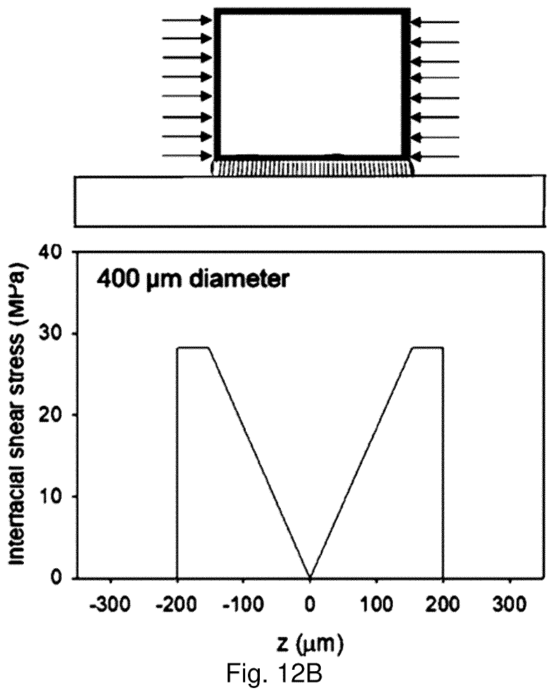

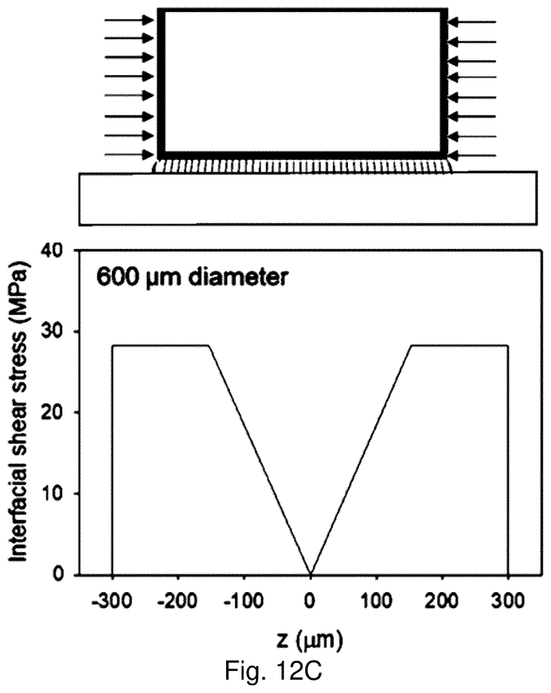

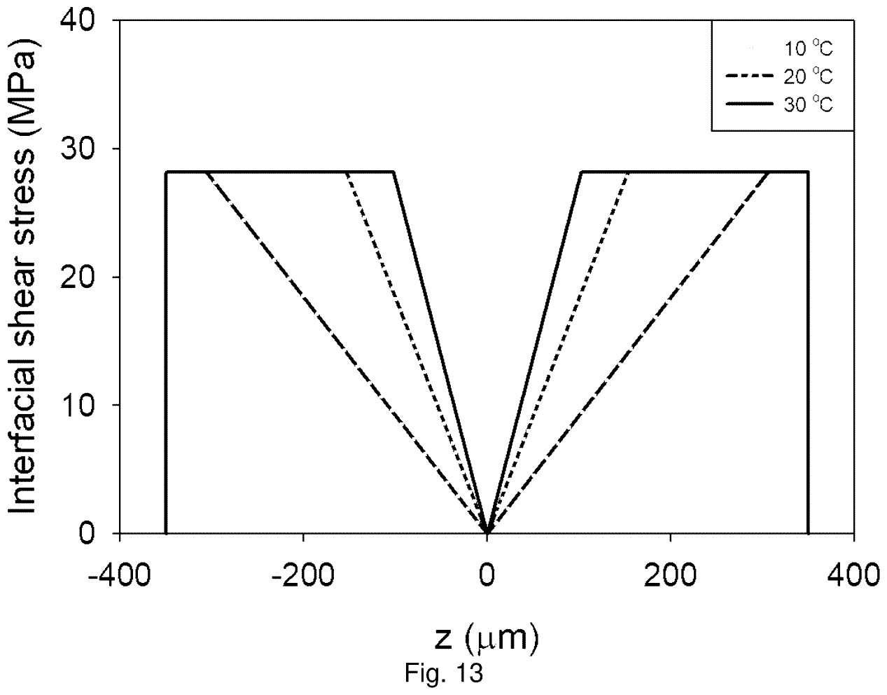

The shear stress at the silicon-interlayer alloy interface is a function of geometry (pin diameter) and temperature decrease, which is in agreement with the experiments. It is observed that with a temperature decrease of 20° C. between the two layers, samples with diameters of 200 μm, 400 μm, and 600 μm (FIGS. 12A, 12B, and 12C, respectively), results in the respective maximum normal stress of about 54.6 MPa, 103.2 MPa, 114.7 MPa at the silicon interface, by assuming a 1-nm transitional distance on the edge of the interfacial shear stress distribution profile. These calculated normal stress values can be deemed as the upper bound of the normal stress because a larger transitional distance leads to smaller normal stress. Furthermore, by keeping the pin diameter at a constant value of 700 and changing the ΔT, shear stress at the interface changes (FIG. 13).

While this model is a simplification, it demonstrates the importance of using small heating and cooling segments, and lowering the ΔT between neighboring layers. This model was developed for dissimilar materials, but even a homogeneous material system will have thermal stress that is a function of the length of the melted line, temperature difference between layers, the coefficient of thermal expansion. The stress levels in the interlayer and silicon with the segmentation strategy will be lower than the conventional approach because a concentric laser raster around a previously formed feature will rewarm the interior proximal interlayer, thereby allowing relaxation of stress through relative deformation. This relaxation occurs due to the heat treatment lowering the yield limit and/or creep, thereby allowing relative motion of the previously printed neighboring region to relieve and lower residual stresses.

The disclosure has been described with reference to various specific embodiments and techniques. However, many variations and modifications are possible while remaining within the scope of the disclosure.

It will be appreciated by those of ordinary skill in the art that the diagrams, schematics, illustrations, and the like represent conceptual views or processes illustrating systems and methods embodying this invention. The functions of the various elements shown in the figures may be provided through the use of dedicated hardware as well as hardware capable of executing associated software.

As used herein in this document, the terms “coupled to” and “coupled with” are also used euphemistically to mean “communicatively coupled with” over a network, where two or more devices are able to exchange data with each other over the network, possibly via one or more intermediary device.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

While the foregoing describes various embodiments of the invention, other and further embodiments of the invention may be devised without departing from the basic scope thereof. The scope of the invention is determined by the claims that follow. The invention is not limited to the described embodiments, versions or examples, which are included to enable a person having ordinary skill in the art to make and use the invention when combined with information and knowledge available to the person having ordinary skill in the art.

### References

(each of which is expressly incorporated herein by reference in its entirety):
[1] S. N. Schiffres, A. Azizi, Additive manufacturing processes and additively manufactured products, US11167375B2, 2021. patents.google.com/patent/US11167375B2/en (accessed Dec. 10, 2021).
[2] S. N. Schiffres, A. Azizi, Additive manufacturing processes and additively manufactured products, US20200047288A1, 2020. patents.google.com/patent/US20200047288A1/en (accessed Apr. 29, 2020).
[3] P. Mercelis, J. Kruth, Residual stresses in selective laser sintering and selective laser melting, Rapid Prototyping Journal. 12 (2006) 254-265. doi.org/10.1108/13552540610707013.
[4] J. P. Kruth, L. Froyen, J. Van Vaerenbergh, P. Mercelis, M. Rombouts, B. Lauwers, Selective laser melting of iron-based powder, Journal of Materials Processing Technology. 149 (2004) 616-622. doi.org/10.1016/j.jmatprotec.2003.11.051.
[5] Additive Manufacturing & 3D Printing Simulation Software|Ansys, (n.d.). www.ansys.com/products/additive (accessed Oct. 7, 2021).
[6] Functionalities of Simufact Additive-Simufact software solutions, (n.d.). www.simufact.com/funktional-description.html (accessed Oct. 7, 2021).
[7] Netfabb Features|Fusion 360 with Netfabb|Autodesk, (n.d.). www.autodesk.com/products/netfabb/features (accessed Oct. 7, 2021).
[8] W. Zhang, M. Tong, N. M. Harrison, Scanning strategies effect on temperature, residual stress and deformation by multi-laser beam powder bed fusion manufacturing, Additive Manufacturing. 36 (2020) 101507. doi.org/10.1016/j.addma.2020.101507.
[9] B. Cheng, S. Shrestha, K. Chou, Stress and deformation evaluations of scanning strategy effect in selective laser melting, Additive Manufacturing. 12 (2016) 240-251. doi.org/10.1016/j.addma.2016.05.007.
[10] L. N. Carter, C. Martin, P. J. Withers, M. M. Attallah, The influence of the laser scan strategy on grain structure and cracking behaviour in SLM powder-bed fabricated nickel superalloy, Journal of Alloys and Compounds. 615 (2014) 338-347. doi.org/10.1016/j.jallcom.2014.06.172.
[11] L. Parry, I. A. Ashcroft, R. D. Wildman, Understanding the effect of laser scan strategy on residual stress in selective laser melting through thermo-mechanical simulation, Additive Manufacturing. 12 (2016) 1-15. doi.org/10.1016/j.addma.2016.05.014.
[12] D. Ramos, F. Belblidia, J. Sienz, New scanning strategy to reduce warpage in additive manufacturing, Additive Manufacturing. 28 (2019) 554-564. doi.org/10.1016/j.addma.2019.05.016.
[13] L. Ma, H. Bin, Temperature and stress analysis and simulation in fractal scanning-based laser sintering, Int J Adv Manuf Technol. 34 (2007) 898-903. doi.org/10.1007/s00170-006-0665-5.
[14] G. K. White, M. L. Minges, Thermophysical properties of some key solids: An update, Int J Thermophys. 18 (1997) 1269-1327. doi.org/10.1007/BF02575261.
[15] A. Azizi, M. A. Daeumer, S. N. Schiffres, Additive laser metal deposition onto silicon, Additive Manufacturing. 25 (2019) 390-398. doi.org/10.1016/j.addma.2018.09.027.
[16] www.altexsoft.com/blog/schedule-optimization/
[17] towardsdatascience.com/schedule-optimisation-using-linear-programming-in-python-9b3e1bc241e1
[18] Ben Alla, Hicham, Said Ben Alla, Abdellah Touhafi, and Abdellah Ezzati. “A novel task scheduling approach based on dynamic queues and hybrid meta-heuristic algorithms for cloud computing environment.” Cluster Computing 21, no. 4 (2018):1797-1820.
[19] Huang, Jiwei, Chenxiang Zhang, and Jianbing Zhang. “A multi-queue approach of energy efficient task scheduling for sensor hubs.” Chinese Journal of Electronics 29, no. 2 (2020):242-247.
[20] Fera, M., F. Fruggiero, A. Lambiase, R. Macchiaroli, and V. Todisco. “A modified genetic algorithm for time and cost optimization of an additive manufacturing single-machine scheduling.” International Journal of Industrial Engineering Computations 9, no. 4 (2018):423-438.
[21] Udhayakumar, P., and S. Kumanan. “Integrated scheduling of flexible manufacturing system using evolutionary algorithms.” The International Journal of Advanced Manufacturing Technology 61, no. 5 (2012):621-635.
[22] Oh, Yosep, Paul Witherell, Yan Lu, and Timothy Sprock. “Nesting and scheduling problems for additive manufacturing: a taxonomy and review.” Additive Manufacturing 36 (2020):101492.
[23] Wang, Feifan, Sepehr Fathizadan, Feng Ju, Kyle Rowe, and Nils Hofmann. “Print surface thermal modeling and layer time control for large-scale additive manufacturing.” IEEE Transactions on Automation Science and Engineering 18, no. 1 (2020):244-254.
[24] Wang, Feifan, Feng Ju, Kyle Rowe, and Nils Hofmann. “Real-time control for large scale additive manufacturing using thermal images.” In 2019 IEEE 15th International Conference on Automation Science and Engineering (CASE), pp. 36-41. IEEE, 2019.
[25] Fathizadan, Sepehr, Feng Ju, Kyle Rowe, Alex Fiechter, and Nils Hofmann. “A novel real-time thermal analysis and layer time control framework for large-scale additive manufacturing.” Journal of Manufacturing Science and Engineering 143, no. 1 (2021).
[26] Balta, Efe. “Modeling and Intelligent Control for Spatial Processes and Spatially Distributed Systems.” PhD diss., 2021.
[27] Fathizadan, Sepehr, Feng Ju, Feifan Wang, Kyle Rowe, and Nils Hofmann. “Dynamic material deposition control for large-scale additive manufacturing.” IISE Transactions (2021):1-15.
[28] Balta, Efe C., Dawn M. Tilbury, and Kira Barton. “Layer-to-Layer Stability of Linear Layerwise Spatially Varying Systems: Applications in Fused Deposition Modeling.” IEEE Transactions on Control Systems Technology 29, no. 6 (2021):2517-2532.
[29] Balta, Efe C., Ilya Kovalenko, Isaac A. Spiegel, Dawn M. Tilbury, and Kira Barton. “Model predictive control of priced timed automata encoded with first-order logic.” IEEE Transactions on Control Systems Technology 30, no. 1 (2021):352-359.
[30] Fathizadan, Sepehr, Feng Ju, and Yan Lu. “Deep representation learning for process variation management in laser powder bed fusion.” Additive Manufacturing 42 (2021):101961.
[31] Lensgraf, Samuel, and Ramgopal R. Mettu. “Incorporating kinematic properties into fused deposition toolpath optimization.” In 2018 IEEE/RSJ International Conference on Intelligent Robots and Systems (IROS), pp. 8622-8627. IEEE, 2018.
[32] Aksoy, Doruk, Efe C. Balta, Dawn M. Tilbury, and Kira Barton. “A control-oriented model for bead cross-sectional geometry in fused deposition modeling.” In 2020 American Control Conference (ACC), pp. 474-480. IEEE, 2020.
[33] Guo, Shenghan, Weihong “Grace Guo, and Linkan Bain. “Hierarchical spatial-temporal modeling and monitoring of melt pool evolution in laser-based additive manufacturing.” IISE Transactions 52, no. 9 (2020):977-997.
[34] Guo, Shenghan, Mohit Agarwal, Clayton Cooper, Qi Tian, Robert X. Gao, Weihong Guo Grace, and Y. B. Guo. “Machine learning for metal additive manufacturing: Towards a physics-informed data-driven paradigm.” Journal of Manufacturing Systems 62 (2022):145-163.
[35] Joshi, Ameet V. “Linear Methods.” In Machine Learning and Artificial Intelligence, pp. 33-41. Springer, Cham, 2020.
[36] Hertlein, Nathan, Philip R. Buskohl, Andrew Gillman, Kumar Vemaganti, and Sam Anand. “Generative adversarial network for early-stage design flexibility in topology optimization for additive manufacturing.” Journal of Manufacturing Systems 59 (2021):675-685.
[37] Yazdi, Reza Mojahed, Farhad Imani, and Hui Yang. “A hybrid deep learning model of process-build interactions in additive manufacturing.” Journal of Manufacturing Systems 57 (2020):460-468.

U.S. Patent and Patent Application Nos. RE41584; RE43661; RE44817; RE44820; RE46275; U.S. Pat. Nos. 4,026,677; 4,034,454; 4,034,906; 4,065,302; 4,074,208; 4,171,339; 4,173,614; 4,234,661; 4,241,135; 4,358,506; 4,380,574; 4,396,677; 4,459,062; 4,510,171; 4,518,468; 4,553,856; 4,640,816; 4,683,019; 4,699,310; 4,714,624; 4,725,509; 4,748,085; 4,818,628; 4,861,751; 4,863,538; 4,873,152; 4,880,614; 4,888,127; 4,911,987; 4,916,022; 4,938,816; 4,944,817; 4,956,011; 4,985,313; 5,015,502; 5,034,274; 5,039,990; 5,047,386; 5,053,090; 5,071,828; 5,076,869; 5,087,515; 5,099,759; 5,104,849; 5,132,143; 5,132,278; 5,135,817; 5,147,587; 5,154,425; 5,155,321; 5,155,324; 5,156,697; 5,182,170; 5,188,164; 5,194,161; 5,204,302; 5,207,371; 5,209,987; 5,224,969; 5,234,715; 5,247,986; 5,255,730; 5,262,202; 5,266,357; 5,270,296; 5,281,789; 5,289,967; 5,296,062; 5,316,580; 5,326,525; 5,328,717; 5,338,598; 5,342,812; 5,350,637; 5,352,519; 5,362,523; 5,366,570; 5,378,500; 5,382,308; 5,422,209; 5,429,843; 5,431,967; 5,433,280; 5,434,027; 5,458,480; 5,458,705; 5,474,043; 5,476,725; 5,490,911; 5,498,298; 5,503,703; 5,516,725; 5,526,914; 5,538,674; 5,544,550; 5,580,403; 5,593,531; 5,597,589; 5,616,294; 5,620,791; 5,622,577; 5,624,505; 5,628,945; 5,639,070; 5,648,177; 5,669,436; 5,683,825; 5,686,178; 5,694,184; 5,709,958; 5,730,925; 5,741,376; 5,747,111; 5,761,787; 5,770,273; 5,834,070; 5,837,960; 5,865,909; 5,873,771; 5,880,692; 5,898,493; 5,939,201; 5,939,224; 5,948,541; 5,952,253; 5,957,006; 5,964,020; 5,976,716; 5,989,728; 5,993,701; 5,993,979; 6,001,461; 6,017,628; 6,019,878; 6,046,426; 6,054,185; 6,077,615; 6,085,122; 6,086,959; 6,096,436; 6,117,533; 6,119,483; 6,128,918; 6,129,996; 6,143,378; 6,144,008; 6,159,267; 6,163,961; 6,187,700; 6,202,734; 6,214,195; 6,215,093; 6,232,037; 6,261,493; 6,267,864; 6,277,169; 6,300,263; 6,300,389; 6,322,897; 6,341,952; 6,350,386; 6,355,338; 6,360,562; 6,372,346; 6,377,729; 6,391,251; 6,397,922; 6,409,902; 6,423,387; 6,427,489; 6,430,965; 6,432,752; 6,448,108; 6,454,811; 6,459,069; 6,476,343; 6,513,433; 6,514,798; 6,526,778; 6,528,145; 6,531,704; 6,534,194; 6,537,648; 6,537,689; 6,540,800; 6,541,695; 6,544,813; 6,551,760; 6,555,299; 6,558,841; 6,566,035; 6,583,040; 6,583,379; 6,589,311; 6,593,061; 6,593,171; 6,596,150; 6,596,224; 6,607,844; 6,612,478; 6,613,697; 6,617,546; 6,620,861; 6,627,824; 6,629,559; 6,635,357; 6,635,846; 6,643,442; 6,663,982; 6,667,229; 6,669,774; 6,669,989; 6,673,387; 6,673,710; 6,676,728; 6,676,892; 6,682,780; 6,682,872; 6,689,186; 6,699,304; 6,713,519; 6,723,279; 6,730,252; 6,730,410; 6,730,998; 6,740,464; 6,749,101; 6,750,023; 6,756,561; 6,765,151; 6,767,499; 6,770,514; 6,771,009; 6,779,951; 6,780,305; 6,791,164; 6,797,313; 6,797,449; 6,800,400; 6,800,417; 6,800,506; 6,800,574; 6,806,478; 6,811,744; 6,814,823; 6,824,689; 6,828,507; 6,830,643; 6,845,635; 6,847,699; 6,852,010; 6,858,374; 6,858,816; 6,866,929; 6,871,514; 6,875,949; 6,881,483; 6,890,801; 6,893,732; 6,899,777; 6,909,173; 6,909,192; 6,913,184; 6,914,024; 6,925,346; 6,929,865; 6,930,278; 6,933,595; 6,939,505; 6,942,830; 6,951,779; 6,974,070; 6,974,501; 6,979,646; 6,989,200; 6,995,334; 7,004,994; 7,005,191; 7,008,969; 7,009,297; 7,011,760; 7,015,128; 7,020,539; 7,022,165; 7,026,191; 7,034,246; 7,040,953; 7,043,330; 7,045,738; 7,052,241; 7,060,222; 7,064,012; 7,071,089; 7,071,573; 7,076,959; 7,094,473; 7,094,676; 7,097,938; 7,105,217; 7,112,521; 7,122,279; 7,129,575; 7,132,741; 7,145,244; 7,148,286; 7,157,188; 7,162,302; 7,169,478; 7,169,489; 7,172,663; 7,174,637; 7,190,080; 7,192,673; 7,195,842; 7,205,654; 7,212,095; 7,229,853; 7,232,706; 7,235,330; 7,235,736; 7,239,015; 7,241,416; 7,241,533; 7,245,297; 7,259,032; 7,268,421; 7,282,444; 7,285,337; 7,285,496; 7,287,960; 7,288,576; 7,299,749; 7,300,559; 7,305,367; 7,309,548; 7,311,944; 7,312,168; 7,318,983; 7,319,265; 7,321,012; 7,326,434; 7,335,608; 7,338,741; 7,351,773; 7,354,471; 7,358,008; 7,361,239; 7,381,517; 7,384,680; 7,393,559; 7,396,703; 7,405,326; 7,410,728; 7,413,109; 7,416,835; 7,417,314; 7,420,065; 7,425,759; 7,432,014; 7,438,990; 7,446,419; 7,451,906; 7,453,140; 7,455,458; 7,459,233; 7,459,385; 7,462,897; 7,476,469; 7,514,174; 7,521,567; 7,521,928; 7,537,664; 7,538,415; 7,560,138; 7,575,039; 7,597,769; 7,604,897; 7,608,178; 7,621,976; 7,622,424; 7,625,668; 7,626,665; 7,629,058; 7,629,480; 7,631,518; 7,635,617; 7,642,468; 7,645,543; 7,666,233; 7,666,568; 7,674,555; 7,678,668; 7,682,970; 7,691,279; 7,695,248; 7,705,264; 7,716,802; 7,722,731; 7,726,872; 7,727,846; 7,736,542; 7,736,794; 7,745,050; 7,750,483; 7,759,007; 7,771,547; 7,777,155; 7,781,376; 7,782,433; 7,794,881; 7,820,332; 7,825,007; 7,833,827; 7,838,130; 7,838,170; 7,851,804; 7,858,205; 7,867,907; 7,896,222; 7,927,710; 7,932,165; 7,939,126; 7,940,361; 7,964,262; 7,967,570; 7,968,026; 7,976,985; 7,977,405; 7,989,068; 7,997,472; 8,003,416; 8,007,178; 8,007,557; 8,007,929; 8,017,263; 8,021,138; 8,025,983; 8,025,984; 8,043,684; 8,048,571; 8,063,489; 8,066,946; 8,071,007; 8,071,419; 8,079,141; 8,097,301; 8,097,303; 8,111,215; 8,114,211; 8,119,267; 8,119,288; 8,119,314; 8,119,315; 8,124,245; 8,128,866; 8,129,823; 8,137,525; 8,173,010; 8,173,258; 8,173,269; 8,182,939; 8,182,943; 8,202,649; 8,211,226; 8,216,439; 8,221,921; 8,236,452; 8,247,142; 8,268,099; 8,268,100; 8,273,194; 8,313,560; 8,319,350; 8,323,820; 8,326,024; 8,334,075; 8,339,837; 8,353,574; 8,354,136; 8,357,311; 8,357,731; 8,359,744; 8,361,873; 8,367,224; 8,372,330; 8,372,685; 8,375,581; 8,377,999; 8,383,985; 8,387,229; 8,389,060; 8,389,147; 8,394,168; 8,394,495; 8,410,016; 8,414,424; 8,425,651; 8,428,671; 8,435,477; 8,436,130; 8,436,833; 8,440,498; 8,455,131; 8,455,331; 8,457,930; 8,465,847; 8,466,095; 8,479,393; 8,480,754; 8,487,439; 8,488,994; 8,497,312; 8,507,132; 8,509,933; 8,512,808; 8,513,562; 8,535,049; 8,546,161; 8,546,717; 8,552,088; 8,556,981; 8,556,983; 8,563,872; 8,568,684; 8,575,513; 8,586,199; and 8,586,492; 8,591,997; 8,592,057; 8,598,523; 8,604,350; 8,606,540; 8,610,120; 8,610,761; 8,617,640; 8,617,661; 8,617,994; 8,623,026; 8,623,554; 8,628,987; 8,629,564; 8,632,850; 8,634,228; 8,636,194; 8,637,864; 8,642,965; 8,652,686; 8,654,566; 8,658,304; 8,666,142; 8,671,726; 8,673,050; 8,673,477; 8,678,802; 8,685,520; 8,690,472; 8,691333; 8,692,127; 8,697,322; 8,708,458; 8,718,522; 8,723,176; 8,728,387; 8,728,807; 8,734,657; 8,735773; 8,740,598; 8,746,013; 8,748,241; 8,753,105; 8,759,473; 8,765,837; 8,766,253; 8,775,133; 8,778538; 8,783,063; 8,789,626; 8,789,998; 8,790,768; 8,790,793; 8,790,858; 8,795,833; 8,795,899; 8,796683; 8,796,825; 8,797,487; 8,801,418; 8,802,286; 8,807,203; 8,809,780; 8,810,035; 8,815,974; 8,821060; 8,822,875; 8,826,511; 8,828,116; 8,828,311; 8,828,579; 8,829,528; 8,840,831; 8,842,358; 8,844,782; 8,844,877; 8,852,801; 8,853,867; 8,860,021; 8,875,976; 8,877,874; 8,879,957; 8,882,442; 8,883,314; 8,884,284; 8,893,954; 8,901,558; 8,906,107; 8,906,462; 8,906,469; 8,907,871; 8,907,879; 8,915,728; 8,916,085; 8,916,406; 8,916,424; 8,919,150; 8,921,473; 8,926,389; 8,926,706; 8,931,171; 8,931,880; 8,932,060; 8,932,184; 8,932,771; 8,946,704; 8,951,650; 8,952,380; 8,952,678; 8,956,478; 8,956,766; 8,956,912; 8,957,468; 8,960,523; 8,962,188; 8,963,148; 8,969,867; 8,974,105; 8,974,539; 8,976,997; 8,979,606; 8,980,115; 8,983,098; 8,985,497; 8,98,6234; 8,986,880; 8,987,728; 8,988,116; 8,992,703; 8,9946,95; 8,999,200; 9,005,821; 9,006,733; 9,011,620; 9,018,667; 9,020,788; 9,023,566; 9,029,058; 9,034,048; 9,034,442; 9,035,867; 9,040,975; 9,040,981; 9,045,335; 9,048,665; 9,054,364; 9,061,465; 9,070,399; 9,070,729; 9,073,150; 9,073,260; 9,073,261; 9,073,262; 9,075,409; 9,076,825; 9,078,294; 9,079,246; 9,079,248; 9,079,355; 9,079,386; 9,082,861; 9,083,054; 9,090,428; 9,090,955; 9,093,383; 9,097,995; 9,101,978; 9,102,007; 9,102,099; 9,102,566; 9,105,869; 9,107,725; 9,109,429; 9,112,086; 9,112,168; 9,112,272; 9,113,571; 9,114,478; 9,114,567; 9,117,662; 9,120,270; 9,126,365; 9,126,367; 9,127,515; 9,130,358; 9,133,429; 9,136,568; 9,141,015; 9,142,679; 9,142,681; 9,144,940; 9,144,961; 9,145,363; 9,149,952; 9,149,988; 9,153,436; 9,156,205; 9,156,240; 9,157,465; 9,157,735; 9,166,019; 9,166,061; 9,168,573; 9,168,697; 9,171,787; 9,175,174; 9,176,571; 9,180,010; 9,181,790; 9,184,160; 9,184,355; 9,186,270; 9,186,295; 9,186,846; 9,186,848; 9,190,529; 9,190,666; 9,192,990; 9,192,999; 9,196,760; 9,198,829; 9,199,044; 9,199,345; 9,204,945; 9,205,204; 9,205,578; 9,209,480; 9,211,669; 9,214,566; 9,218,966; 9,219,161; 9,220,328; 9,221,100; 9,222,932; 9,227,243; 9,227,339; 9,227,365; 9,228,859; 9,231,410; 9,233,506; 9,236,428; 9,236,606; 9,241,869; 9,243,475; 9,248,611; 9,252,283; 9,252,286; 9,254,535; 9,258,651; 9,260,390; 9,263,259; 9,264,090; 9,269,520; 9,269,647; 9,272,946; 9,278,483; 9,279,328; 9,281,517; 9,283,593; 9,284,212; 9,287,405; 9,287,521; 9,287,573; 9,287,916; 9,289,826; 9,290,407; 9,296,039; 9,296,129; 9,296,190; 9,302,338; 9,308,583; 9,308,616; 9,308,691; 9,310,188; 9,315,043; 9,318,484; 9,320,620; 9,324,875; 9,326,780; 9,327,056; 9,327,350; 9,327,447; 9,327,452; 9,327,453; 9,330,909; 9,331,156; 9,331,251; 9,332,251; 9,333,148; 9,339,993; 9,341,467; 9,346,116; 9,346,127; 9,347,770; 9,350,005; 9,351,083; 9,352,421; 9,354,029; 9,358,350; 9,358,729; 9,359,513; 9,362,972; 9,364,888; 9,369,259; 9,369,553; 9,370,896; 9,375,298; 9,375,782; 9,387,079; 9,390,312; 9,399,256; 9,399,264; 9,399,321; 9,402,313; 9,403,235; 9,406,483; 9,406,698; 9,407,746; 9,408,781; 9,414,501; 9,414,513; 9,415,438; 9,419,299; 9,419,502; 9,421,715; 9,423,756; 9,428,826; 9,431,430; 9,434,633; 9,435,915; 9,437,744; 9,439,767; 9,440,397; 9,440,853; 9,442,105; 9,442,395; 9,446,475; 9,446,979; 9,452,474; 9,452,489; 9,453,142; 9,456,777; 9,456,901; 9,457,428; 9,457,521; 9,460,557; 9,463,506; 9,466,725; 9,468,317; 9,471,172; 9,472,310; 9,472,656; 9,474,688; 9,474,689; 9,475,947; 9,476,685; 9,477,346; 9,478,422; 9,481,931; 9,482,103; 9,482,105; 9,482,974; 9,484,277; 9,486,878; 9,486,944; 9,486,963; 9,486,964; 9,488,456; 9,490,350; 9,490,351; 9,494,829; 9,496,375; 9,499,779; 9,505,648; 9,507,061; 9,507,274; 9,508,667; 9,508,979; 9,511,005; 9,511,543; 9,511,547; 9,512,029; 9,512,544; 9,517,134; 9,522,836; 9,523,934; 9,527,165; 9,527,240; 9,527,242; 9,527,244; 9,527,246; 9,528,705; 9,528,902; 9,530,895; 9,533,350; 9,533,372; 9,533,450; 9,533,485; 9,533,526; 9,536,844; 9,543,116; 9,545,017; 9,545,669; 9,555,475; 9,555,612; 9,556,415; 9,556,505; 9,557,331; 9,557,661; 9,559,213; 9,561,622; 9,561,623; 9,564,457; 9,564,589; 9,564,938; 9,565,910; 9,566,758; 9,570,789; 9,573,193; 9,573,224; 9,573,225; 9,575,037; 9,578,695; 9,579,718; 9,579,829; 9,579,851; 9,583,856; 9,586,285; 9,586,290; 9,586,298; 9,586,364; 9,587,296; 9,587,317; 9,592,530; 9,593,924; 9,598,606; 9,599,766; 9,601,779; 9,603,711; 9,603,775; 9,603,780; 9,604,280; 9,608,124; 9,608,228; 9,611,167; 9,614,062; 9,614,100; 9,614,160; 9,617,865; 9,623,512; 9,625,156; 9,625,764; 9,626,608; 9,636,229; 9,636,769; 9,636,770; 9,636,775; 9,636,868; 9,642,727; 9,643,250; 9,643,279; 9,643,281; 9,643,361; 9,649,690; 9,655,293; 9,655,293; 9,656,429; 9,656,877; 9,660,265; 9,661,423; 9,662,840; 9,663,400; 9,664,504; 9,664,505; 9,666,896; 9,668,944; 9,669,583; 9,670,782; 9,676,145; 9,676,159; 9,676,653; 9,676,963; 9,682,019; 9,682,166; 9,682,425; 9,688,028; 9,688,540; 9,690,286; 9,694,423; 9,694,545; 9,696,142; 9,700,485; 9,700,486; 9,705,099; 9,707,153; 9,707,154; 9,707,155; 9,707,717; 9,708,440; 9,713,572; 9,713,843; 9,714,318; 9,715,563; 9,717,648; 9,717,649; 9,718,127; 9,720,363; 9,721,384; 9,721,755; 9,722,275; 9,724,727; 9,728,648; 9,728,773; 9,729,187; 9,731,377; 9,732,239; 9,735,428; 9,737,934; 9,742,001; 9,744,722; 9,744,730; 9,744,743; 9,745,223; 9,746,257; 9,747,394; 9,751,610; 9,752,835; 9,755,191; 9,757,802; 9,764,418; 9,764,435; 9,764,515; 9,765,167; 9,765,271; 9,765,635; 9,765,727; 9,768,026; 9,769,573; 9,770,758; 9,770,760; 9,770,866; 9,771,400; 9,771,629; 9,772,621; 9,774,192; 9,775,680; 9,776,243; 9,776,282; 9,776,376; 9,777,134; 9,777,385; 9,780,348; 9,782,932; 9,782,935; 9,783,718; 9,783,885; 9,785,064; 9,788,600; 9,789,665; 9,790,124; 9,793,057; 9,795,541; 9,796,048; 9,802,253; 9,808,991; 9,812,467; 9,812,582; 9,815,118; 9,815,139; 9,815,144; 9,815,268; 9,818,715; 9,821,399; 9,821,411; 9,821,546; 9,822,045; 9,826,652; 9,827,754; 9,828,679; 9,832,866; 9,833,838; 9,833,839; 9,833,949; 9,833,987; 9,835,428; 9,836,883; 9,838018; 9,839,579; 9,839,977; 9,849,066; 9,849,510; 9,849,543; 9,850,160; 9,850,172; 9,852,904; 9,855369; 9,855,625; 9,855,698; 9,857,860; 9,859,114; 9,861,452; 9,862,146; 9,862,617; 9,868,255; 9,869734; 9,871,059; 9,871,176; 9,871,209; 9,873,180; 9,873,228; 9,873,281; 9,873,761; 9,877,790; 9,878497; 9,881,744; 9,882,111; 9,885,987; 9,886,526; 9,887,066; 9,890,091; 9,896,944; 9,897,513; 9,899136; 9,899,672; 9,902,112; 9,902,588; 9,903,037; 9,903,214; 9,903,574; 9,904,223; 9,905,516; 9,905860; 9,908,803; 9,911,874; 9,915,480; 9,915,583; 9,915,756; 9,916,958; 9,917,263; 9,919,111; 9,919112; 9,919,273; 9,919,360; 9,919,361; 9,919,472; 9,919,479; 9,920,433; 9,922,759; 9,923,000; 9,923166; 9,925,714; 9,925,724; 9,926,427; 9,931,695; 9,931,697; 9,931,814; 9,931,817; 9,932,663; 9,932841; 9,933,718; 9,933,820; 9,937,580; 9,938,839; 9,943,927; 9,943,929; 9,943,981; 9,944,021; 9,945032; 9,947,964; 9,950,367; 9,950,465; 9,953,899; 9,954,212; 9,956,047; 9,956,048; 9,956,107; 9,956612; 9,956,725; 9,956,727; 9,959,613; 9,960,122; 9,962,767; 9,964,514; 9,969,000; 9,969,153; 9,969930; 9,970,824; 9,972,802; 9,975,179; 9,975,199; 9,975,296; 9,975,323; 9,981,425; 9,982,164; 9,982684; 9,987,798; 9,987,804; 9,988,720; 9,990,965; 9,991,221; 9,991,293; 9,991,395; 9,991,453; 9,993395; 9,993,976; 9,993,982; 9,994,339; 9,996,981; 9,997,545; 9,997,784; 9,999,576; 9,999,920; 10,000,023; 10,002,685; 10,005,227; 10,005,228; 10,005,230; 10,005,237; 10,008,870; 10,011,076; 10,011,089; 10,011,352; 10,016,262; 10,016,661; 10,016,942; 10,018,937; 10,022,614; 10,022,797; 10,023,495; 10,023,739; 10,029,422; 10,029,424; 10,029,461; 10,035,306; 10,035,920; 10,039,195; 10,040,239; 10,040,240; 10,040,250; 10,040,252; 10,040,810; 10,045,835; 10,046,494; 10,046,521; 10,046,524; 10,051,753; 10,052,159; 10,052,691; 10,054,530; 10,058,920; 10,059,053; 10,059,057; 10,059,092; 10,059,595; 10,060,217; 10,061,221; 10,064,737; 10,064,745; 10,065,270; 10,065,367; 10,065,371; 10,065,885; 10,068,863; 10,071,422; 10,076,875; 10,076,876; 10,081,129; 10,082,605; 10,086,564; 10,087,556; 10,089,413; 10,091,891; 10,093,039; 10,096,537; 10,099,309; 10,099,427; 10,105,902; 10,105,906; 10,112,345; 10,112,379; 10,116,777; 10,117,806; 10,117,810; 10,118,054; 10,118,337; 10,123,807; 10,123,947; 10,124,408; 10,124,410; 10,124,532; 10,124,539; 10,131,088; 10,131,131; 10,132,578; 10,134,766; 10,135,002; 10,135,109; 10,136,689; 10,137,634; 10,137,636; 10,137,642; 10,137,667; 10,144,176; 10,144,178; 10,144,205; 10,144,828; 10,144,840; 10,145,271; 10,149,505; 10,150,258; 10,151,049; 10,151,377; 10,153,608; 10,155,882; 10,156,185; 10,157,503; 10,160,061; 10,160,193; 10,162,084; 10,166,744; 10,170,500; 10,170,726; 10,172,400; 10,172,695; 10,173,258; 10,173,916; 10,173,945; 10,174,205; 10,174,276; 10,179,640; 10,181,017; 10,182,869; 10,183,329; 10,183,330; 10,183,443; 10,183,477; 10,189,057; 10,189,114; 10,189,204; 10,189,210; 10,189,239; 10,190,244; 10,190,955; 10,195,629; 10,195,643; 10,195,693; 10,195,816; 10,196,295; 10,200,834; 10,201,409; 10,201,931; 10,202,216; 10,207,327; 10,211,143; 10,247,106; 10,252,335; 10,252,336; 10,272,525; 10,303,157; 10,309,728; 10,323,887; 10,357,957; 10,361,597; 10,384,263; 10,415,408; 10,422,586; 10,449,696; 10,450,220; 10,463,500; 10,471,695; 10,480,868; 10,494,948; 10,495,309; 10,501,312; 10,518,480; 10,549,478; 10,549,520; 10,558,199; 10,583,484; 10,589,353; 10,611,092; 10,612,860; 10,613,496; 10,619,929; 10,632,730; 10,639,861; 10,643,862; 10,654,133; 10,654,195; 10,668,533; 10,668,534; 10,714,300; 10,718,574; 10,722,947; 10,731,565; 10,766,194; 10,792,766; 10,807,305; 10,821,509; 10,828,700; 10,864,577; 10,882,112; 10,906,101; 10,946,448; 10,960,603; 10,974,476; 10,974,498; 10,975,460; 10,981,227; 10,983,504; 10,994,485; 11,000,896; 11,007,738; 11,009,863; 11,020,908; 11,046,609; 11,065,689; 11,077,964; 11,084,097; 11,084,225; 11,090,723; 11,117,194; 11,117,320; 11,135,773; 11,137,143; 11,141,922; 11,148,319; 11,167,375; 11,174,152; 11,182,520; 11,186,684; 11,187,149; 11,192,187; 11,193,019; 11,209,223; 2019067471; 2021097248; 20010000889; 20010008230; 20010008317; 20010018159; 20010021292; 20010028990; 20010038029; 20010039810; 20010043996; 20020007751; 20020009626; 20020015654; 20020025493; 20020031731; 20020041137; 20020056401; 20020062858; 20020066233; 20020066966; 20020069592; 20020081447; 20020082171; 20020084527; 20020090821; 20020092325; 20020096805; 20020096806; 20020098381; 20020098776; 20020108400; 20020110698; 20020144838; 20020153253; 20020154741; 20020158054; 20020160308; 20020160685; 20020168051; 20020173416; 20020177003; 20020182782; 20020192494; 20020192564; 20020195676; 20030003474; 20030009126; 20030019326; 20030022094; 20030029910; 20030039459; 20030044593; 20030068575; 20030070916; 20030090034; 20030108795; 20030109202; 20030111719; 20030113506; 20030114936; 20030116503; 20030116542; 20030119920; 20030127051; 20030128428; 20030129787; 20030138733; 20030161750; 20030162127; 20030173720; 20030180571; 20030189082; 20030201255; 20030203205; 20030206820; 20030211657; 20040009402; 20040014259; 20040016769; 20040016912; 20040018432; 20040023087; 20040035910; 20040036161; 20040056022; 20040071882; 20040081895; 20040096742; 20040099996; 20040100164; 20040102539; 20040106060; 20040112478; 20040133298; 20040138363; 20040147620; 20040149806; 20040154488; 20040161789; 20040168637; 20040182835; 20040191106; 20040192063; 20040192171; 20040197650; 20040202883; 20040206267; 20040209756; 20040210289; 20040219295; 20040221515; 20040224258; 20040231758; 20040234866; 20040234883; 20040242792; 20040247782; 20040249428; 20040254419; 20040261420; 20040265736; 20050007105; 20050008939; 20050009245; 20050013759; 20050023508; 20050025797; 20050031891; 20050036893; 20050036898; 20050040090; 20050040505; 20050044987; 20050045034; 20050048571; 20050054510; 20050056806; 20050061107; 20050064291; 20050065035; 20050069640; 20050079132; 20050089627; 20050095442; 20050098609; 20050100790; 20050106495; 20050107870; 20050118482; 20050119725; 20050127334; 20050133527; 20050142377; 20050147752; 20050148115; 20050149002; 20050149169; 20050151228; 20050153161; 20050153208; 20050155779; 20050165471; 20050172643; 20050174208; 20050175822; 20050182482; 20050202343; 20050207931; 20050216075; 20050227148; 20050230029; 20050233886; 20050240100; 20050244337; 20050255694; 20050261763; 20050278020; 20050285823; 20060001726; 20060003497; 20060021221; 20060027625; 20060032838; 20060035149; 20060051600; 20060060956; 20060062684; 20060071359; 20060081571; 20060094603; 20060102871; 20060108567; 20060118758; 20060119249; 20060135344; 20060141362; 20060142853; 20060147138; 20060147332; 20060147369; 20060147631; 20060151582; 20060160919; 20060166159; 20060166406; 20060167120; 20060169979; 20060172073; 20060185473; 20060216539; 20060216604; 20060224027; 20060225817; 20060226421; 20060227695; 20060228475; 20060234127; 20060235060; 20060246725; 20060249705; 20060274510; 20060276875; 20060280998; 20070000129; 20070002239; 20070010702; 20070029927; 20070048531; 20070054189; 20070061006; 20070065675; 20070068605; 20070072113; 20070093006; 20070099088; 20070104605; 20070111893; 20070122549; 20070122707; 20070122710; 20070128520; 20070128521; 20070134096; 20070140065; 20070141375; 20070141469; 20070142914; 20070151087; 20070152026; 20070158200; 20070160315; 20070178384; 20070183918; 20070187464; 20070189986; 20070203584; 20070214467; 20070227627; 20070251389; 20070259220; 20070298325; 20070298351; 20080008894; 20080012801; 20080015284; 20080015494; 20080026220; 20080032192; 20080041921; 20080047599; 20080052904; 20080057203; 20080057267; 20080057395; 20080057616; 20080075878; 20080075984; 20080087629; 20080087986; 20080106261; 20080110491; 20080139342; 20080145707; 20080152998; 20080156475; 20080175982; 20080188373; 20080201008; 20080210413; 20080213718; 20080233434; 20080241660; 20080241705; 20080268618; 20080274355; 20080280201; 20080280424; 20080284719; 20080284768; 20080290329; 20080290795; 20080299459; 20080302418; 20080306182; 20080308792; 20080317951; 20090000480; 20090004764; 20090004878; 20090011575; 20090014055; 20090028697; 20090043116; 20090046441; 20090075083; 20090076189; 20090081066; 20090098674; 20090110954; 20090114797; 20090117466; 20090117707; 20090123690; 20090127544; 20090131203; 20090136769; 20090155676; 20090160325; 20090178741; 20090206065; 20090208752; 20090214373; 20090214857; 20090235915; 20090267491; 20090269497; 20090269605; 20090283501; 20090284138; 20090286008; 20090288952; 20090291312; 20090291345; 20090297718; 20090311598; 20090317658; 20100010638; 20100013096; 20100015330; 20100021565; 20100029036; 20100035375; 20100036075; 20100048762; 20100056026; 20100062179; 20100068464; 20100078830; 20100089976; 20100089977; 20100102446; 20100112192; 20100119846; 20100125356; 20100126132; 20100130682; 20100132765; 20100133688; 20100139840; 20100143601; 20100174392; 20100178571; 20100190038; 20100190054; 20100193830; 20100196750; 20100203706; 20100209328; 20100210049; 20100216034; 20100216907; 20100221567; 20100224867; 20100227071; 20100227157; 20100228025; 20100229940; 20100236288; 20100242843; 20100255362; 20100261144; 20100262054; 20100262272; 20100267856; 20100279000; 20100285207; 20100291286; 20100291401; 20100291758; 20100300532; 20100305742; 20100310941; 20100313416; 20100314258; 20100315796; 20100326429; 20100330357; 20110003143; 20110003200; 20110006670; 20110008640; 20110014081; 20110015102; 20110016939; 20110027547; 20110029093; 20110032467; 20110047799; 20110052921; 20110061591; 20110065973; 20110087332; 20110089610; 20110104571; 20110108760; 20110111303; 20110114075; 20110114182; 20110114839; 20110120674; 20110136162; 20110139251; 20110143201; 20110144223; 20110165462; 20110166824; 20110169924; 20110195279; 20110206912; 20110211676; 20110214799; 20110237731; 20110240108; 20110240594; 20110245083; 20110248251; 20110253990; 20110259862; 20110269621; 20110278051; 20110290549; 20110291331; 20110293840; 20110293976; 20110295378; 20110297081; 20110297450; 20110305578; 20120007286; 20120009339; 20120012032; 20120024332; 20120028176; 20120032329; 20120034101; 20120040282; 20120040283; 20120041446; 20120044652; 20120045688; 20120051116; 20120052625; 20120056647; 20120061665; 20120061677; 20120062813; 20120063203; 20120064650; 20120065755; 20120067728; 20120085811; 20120100031; 20120113341; 20120114518; 20120115973; 20120128284; 20120129056; 20120132627; 20120132631; 20120135153; 20120138586; 20120146014; 20120156323; 20120164413; 20120171847; 20120181687; 20120191205; 20120191420; 20120193063; 20120193335; 20120194756; 20120195994; 20120196952; 20120201960; 20120205348; 20120207264; 20120208002; 20120208011; 20120209394; 20120214900; 20120219698; 20120231352; 20120232308; 20120232669; 20120232670; 20120232671; 20120237631; 20120238658; 20120241734; 20120243823; 20120244060; 20120255176; 20120261654; 20120264884; 20120270106; 20120279441; 20120296029; 20120298873; 20120298886; 20120308781; 20120316716; 20120322197; 20120326601; 20120328945; 20130001834; 20130002764; 20130004680; 20130008698; 20130008879; 20130017141; 20130017390; 20130025409; 20130026636; 20130028781; 20130029886; 20130031753; 20130034759; 20130034932; 20130036942; 20130043573; 20130045093; 20130054061; 20130056912; 20130061636; 20130062107; 20130064706; 20130065073; 20130068513; 20130071294; 20130075735; 20130079693; 20130092924; 20130092925; 20130092944; 20130101423; 20130101596; 20130101729; 20130101761; 20130105791; 20130108460; 20130109194; 20130112672; 20130119360; 20130119373; 20130119374; 20130126868; 20130134414; 20130134637; 20130136868; 20130137033; 20130140554; 20130140741; 20130147092; 20130149632; 20130153889; 20130155790; 20130161606; 20130161608; 20130161609; 20130161621; 20130162306; 20130166256; 20130168257; 20130168902; 20130172642; 20130181214; 20130184415; 20130186265; 20130186514; 20130187151; 20130192304; 20130193433; 20130193493; 20130193620; 20130196094; 20130196095; 20130196096; 20130196097; 20130196468; 20130197683; 20130199013; 20130199241; 20130200365; 20130200375; 20130202823; 20130203214; 20130209698; 20130209932; 20130210618; 20130211531; 20130213848; 20130216597; 20130216742; 20130219890; 20130232366; 20130233303; 20130233846; 20130236662; 20130241069; 20130248528; 20130260217; 20130263977; 20130264750; 20130266915; 20130268085; 20130270750; 20130274373; 20130280091; 20130289216; 20130291385; 20130295212; 20130300284; 20130305727; 20130309946; 20130313708; 20130338252; 20130343023; 20130344258; 20130344765; 20140001155; 20140007418; 20140008327; 20140008686; 20140013554; 20140014629; 20140021171; 20140025978; 20140034544; 20140034626; 20140035205; 20140035423; 20140035995; 20140037873; 20140037969; 20140039087; 20140039088; 20140039451; 20140039452; 20140039631; 20140039658; 20140047996; 20140050921; 20140051335; 20140052288; 20140061165; 20140061167; 20140061977; 20140063432; 20140065361; 20140065430; 20140079540; 20140079741; 20140079916; 20140091299; 20140095107; 20140099476; 20140103338; 20140103340; 20140103346; 20140104133; 20140106504; 20140109440; 20140110153; 20140110706; 20140113021; 20140120195; 20140120417; 20140127868; 20140130736; 20140131700; 20140131702; 20140134325; 20140136154; 20140140030; 20140140882; 20140141303; 20140145522; 20140151320; 20140151321; 20140151370; 20140151371; 20140151691; 20140154088; 20140154646; 20140162043; 20140163445; 20140163568; 20140172111; 20140174344; 20140175435; 20140177132; 20140178206; 20140182170; 20140184757; 20140186098; 20140189989; 20140190942; 20140194996; 20140203277; 20140204160; 20140209886; 20140209898; 20140216123; 20140217647; 20140222184; 20140227548; 20140228474; 20140228860; 20140231126; 20140231266; 20140231799; 20140231803; 20140246809; 20140249643; 20140252351; 20140252687; 20140255785; 20140263209; 20140264323; 20140265040; 20140265046; 20140265047; 20140265048; 20140265049; 20140265812; 20140271328; 20140271965; 20140272154; 20140272398; 20140277669; 20140286048; 20140291886; 20140294567; 20140295087; 20140306380; 20140312101; 20140314581; 20140319735; 20140319736; 20140319737; 20140319738; 20140322374; 20140328964; 20140329953; 20140332187; 20140335653; 20140336680; 20140338552; 20140338894; 20140339122; 20140339125; 20140339126; 20140339555; 20140341883; 20140341888; 20140341889; 20140341890; 20140341891; 20140341945; 20140342979; 20140346216; 20140349191; 20140353808; 20140360698; 20140361460; 20140363585; 20140366761; 20140368804; 20140370111; 20140370323; 20140370337; 20140370654; 20140373743; 20140374084; 20140374728; 20150001093; 20150001516; 20150017475; 20150021379; 20150021603; 20150021815; 20150024169; 20150024309; 20150024319; 20150027948; 20150029485; 20150030494; 20150030932; 20150032215; 20150034604; 20150037601; 20150041025; 20150041788; 20150044415; 20150045924; 20150045928; 20150048209; 20150050463; 20150053291; 20150054193; 20150054930; 20150054944; 20150054945; 20150060422; 20150064050; 20150064374; 20150064474; 20150064841; 20150069449; 20150069668; 20150071913; 20150076469; 20150079298; 20150080495; 20150089881; 20150090074; 20150093283; 20150093589; 20150093880; 20150094396; 20150100149; 20150102531; 20150103495; 20150104344; 20150104345; 20150108677; 20150108694; 20150113993; 20150114611; 20150116968; 20150118570; 20150123091; 20150125333; 20150125335; 20150126641; 20150129544; 20150129583; 20150130754; 20150132173; 20150132548; 20150132563; 20150135897; 20150136908; 20150137122; 20150139849; 20150140230; 20150140731; 20150141234; 20150145174; 20150145177; 20150147540; 20150147585; 20150152214; 20150155312; 20150155392; 20150155399; 20150155456; 20150158111; 20150161299; 20150165525; 20150165545; 20150165556; 20150167130; 20150174827; 20150179777; 20150179804; 20150179998; 20150182315; 20150183070; 20150184540; 20150196971; 20150197064; 20150197862; 20150198052; 20150202687; 20150202716; 20150202717; 20150207080; 20150207146; 20150209162; 20150209889; 20150210013; 20150214342; 20150214555; 20150217367; 20150219133; 20150219444; 20150219521; 20150224607; 20150224710; 20150227062; 20150227070; 20150228801; 20150231040; 20150231796; 20150231825; 20150231828; 20150231831; 20150239046; 20150243792; 20150246482; 20150246486; 20150247474; 20150251247; 20150251250; 20150251351; 20150251353; 20150252190; 20150258735; 20150259263; 20150259530; 20150259790; 20150266237; 20150266285; 20150270088; 20150270531; 20150273586; 20150273622; 20150273631; 20150275916; 20150283613; 20150283614; 20150283642; 20150283646; 20150283649; 20150285502; 20150285504; 20150290707; 20150290711; 20150290741; 20150290875; 20150293371; 20150298263; 20150299035; 20150300179; 20150306664; 20150306665; 20150306667; 20150306699; 20150306700; 20150311452; 20150314366; 20150314389; 20150314390; 20150315392; 20150320158; 20150321250; 20150321289; 20150322808; 20150328713; 20150328719; 20150333160; 20150336171; 20150338709; 20150340641; 20150343564; 20150343673; 20150348863; 20150349154; 20150351493; 20150352668; 20150352770; 20150352794; 20150357581; 20150360372; 20150360954; 20150366756; 20150367415; 20150367416; 20150367417; 20150367418; 20150367419; 20150367446; 20150367447; 20150367448; 20150367453; 20150367575; 20150367577; 20150368430; 20150371279; 20150371854; 20150372123; 20150374582; 20150374915; 20150374929; 20150374930; 20150375336; 20150375340; 20150376248; 20150380364; 20150380529; 20160001364; 20160001365; 20160001401; 20160001509; 20160003063; 20160003556; 20160005878; 20160008887; 20160008889; 20160008922; 20160009027; 20160009028; 20160009029; 20160009030; 20160009039; 20160010457; 20160010469; 20160013439; 20160014906; 20160018371; 20160022383; 20160023272; 20160023307; 20160023438; 20160023948; 20160024293; 20160024676; 20160030105; 20160032416; 20160033248; 20160038633; 20160039054; 20160039851; 20160040312; 20160043384; 20160043392; 20160043429; 20160045967; 20160045981; 20160047255; 20160052056; 20160052057; 20160052079; 20160052087; 20160052176; 20160052208; 20160054115; 20160054121; 20160054347; 20160056392; 20160056396; 20160059154; 20160059302; 20160059315; 20160059352; 20160059437; 20160061044; 20160061381; 20160061806; 20160064422; 20160064669; 20160066930; 20160067766; 20160067778; 20160067779; 20160067780; 20160067781; 20160067820; 20160067928; 20160069622; 20160071625; 20160074558; 20160074938; 20160074965; 20160075089; 20160075119; 20160079548; 20160082547; 20160082550; 20160082657; 20160082658; 20160082695; 20160083135; 20160083516; 20160089719; 20160089859; 20160090848; 20160093642; 20160095795; 20160095796; 20160096326; 20160098495; 20160099353; 20160101433; 20160101643; 20160101988; 20160104877; 20160107232; 20160107234; 20160107261; 20160107262; 20160107287; 20160107290; 20160107295; 20160114425; 20160114431; 20160114432; 20160114458; 20160115083; 20160120040; 20160121399; 20160121430; 20160122541; 20160126360; 20160128843; 20160129503; 20160129643; 20160131564; 20160135537; 20160136759; 20160136787; 20160136885; 20160136887; 20160136889; 20160136897; 20160137838; 20160137839; 20160141422; 20160143744; 20160144428; 20160144430; 20160144566; 20160145722; 20160145990; 20160146153; 20160151854; 20160151856; 20160151859; 20160151860; 20160151861; 20160153081; 20160153271; 20160153272; 20160158843; 20160158880; 20160158889; 20160159955; 20160160077; 20160163744; 20160163948; 20160164046; 20160166284; 20160167160; 20160167299; 20160167303; 20160167312; 20160168453; 20160168715; 20160172655; 20160175787; 20160175929; 20160175932; 20160175934; 20160175935; 20160181217; 20160181601; 20160184891; 20160184925; 20160184931; 20160186579; 20160186620; 20160187166; 20160190329; 20160190640; 20160193695; 20160193696; 20160193697; 20160193790; 20160199933; 20160200045; 20160200046; 20160200047; 20160201155; 20160202042; 20160202043; 20160202101; 20160204271; 20160207106; 20160207109; 20160207112; 20160211116; 20160211119; 20160214173; 20160214211; 20160215375; 20160218106; 20160221114; 20160221115; 20160221122; 20160221262; 20160221733; 20160222807; 20160223041; 20160228255; 20160228929; 20160228975; 20160228987; 20160228990; 20160228991; 20160228992; 20160229005; 20160230283; 20160233474; 20160233487; 20160235929; 20160236299; 20160237827; 20160240690; 20160242853; 20160242931; 20160243620; 20160243644; 20160243649; 20160243652; 20160244212; 20160244625; 20160244980; 20160247665; 20160248115; 20160250688; 20160250711; 20160250715; 20160250717; 20160250724; 20160254097; 20160254511; 20160254687; 20160256925; 20160258383; 20160260261; 20160260948; 20160263704; 20160264479; 20160265362; 20160265366; 20160271732; 20160271870; 20160271875; 20160271877; 20160271878; 20160271879; 20160271884; 20160273074; 20160273079; 20160273368; 20160273369; 20160273687; 20160276056; 20160279703; 20160279706; 20160279707; 20160279708; 20160279734; 20160279735; 20160282848; 20160288200; 20160288209; 20160288244; 20160288254; 20160288264; 20160288265; 20160288266; 20160288414; 20160289483; 20160297006; 20160297007; 20160297104; 20160297141; 20160297148; 20160298218; 20160298220; 20160298268; 20160301071; 20160303656; 20160303687; 20160303762; 20160303798; 20160305256; 20160305271; 20160307678; 20160307731; 20160310077; 20160310236; 20160310279; 20160310282; 20160311020; 20160311022; 20160311160; 20160311162; 20160311165; 20160311230; 20160312338; 20160312653; 20160313306; 20160317312; 20160318072; 20160318128; 20160318129; 20160318130; 20160318253; 20160319677; 20160319678; 20160321384; 20160324581; 20160325355; 20160325358; 20160325378; 20160325383; 20160325492; 20160325498; 20160325541; 20160326613; 20160326880; 20160326892; 20160332229; 20160332250; 20160332253; 20160332259; 20160332266; 20160332366; 20160332371; 20160332379; 20160332380; 20160332384; 20160336538; 20160339516; 20160339517; 20160339518; 20160339520; 20160339521; 20160339536; 20160339542; 20160339639; 20160339642; 20160339646; 20160340256; 20160340768; 20160346998; 20160348203; 20160348517; 20160349029; 20160351321; 20160354064; 20160354839; 20160354842; 20160354843; 20160355433; 20160355904; 20160358575; 20160358795; 20160359050; 20160361765; 20160361872; 20160361873; 20160363041; 20160367264; 20160368050; 20160368055; 20160368056; 20160368057; 20160368213; 20160369040; 20160369096; 20160370898; 20160375676; 20160376453; 20160376674; 20160377994; 20160378004; 20160380634; 20160381794; 20170001253; 20170001258; 20170001263; 20170001374; 20170001377; 20170001379; 20170001919; 20170002978; 20170005048; 20170005361; 20170007359; 20170007360; 20170007362; 20170007363; 20170007366; 20170007367; 20170007386; 20170008080; 20170008084; 20170008085; 20170008086; 20170008123; 20170008126; 20170008236; 20170008333; 20170009584; 20170014169; 20170014235; 20170014312; 20170014903; 20170014906; 20170014909; 20170014937; 20170014950; 20170015452; 20170016093; 20170016094; 20170016703; 20170016781; 20170021383; 20170021418; 20170021419; 20170021420; 20170021452; 20170021453; 20170021454; 20170021455; 20170021456; 20170021562; 20170021565; 20170021572; 20170021606; 20170022608; 20170023168; 20170025440; 20170027624; 20170028472; 20170028475; 20170028589; 20170028622; 20170028631; 20170028682; 20170028703; 20170029300; 20170030204; 20170030399; 20170031057; 20170033068; 20170033129; 20170036238; 20170036272; 20170036300; 20170036303; 20170036783; 20170036951; 20170037674; 20170037867; 20170038047; 20170043395; 20170043402; 20170044416; 20170045313; 20170047583; 20170050198; 20170050241; 20170050242; 20170050254; 20170050261; 20170050268; 20170050270; 20170050271; 20170050349; 20170051386; 20170051613; 20170051675; 20170053584; 20170056179; 20170057013; 20170059529; 20170066051; 20170066052; 20170066187; 20170066928; 20170067154; 20170067344; 20170067788; 20170068774; 20170069817; 20170072104; 20170072465; 20170072466; 20170072468; 20170072635; 20170074285; 20170080641; 20170087635; 20170087661; 20170087666; 20170087670; 20170087765; 20170088918; 20170090462; 20170092400; 20170092565; 20170095882; 20170095888; 20170100209; 20170100210; 20170100214; 20170100215; 20170100817; 20170100888; 20170100891; 20170100893; 20170100899; 20170101707; 20170101875; 20170103714; 20170104242; 20170106432; 20170106438; 20170106443; 20170106444; 20170106445; 20170106446; 20170106474; 20170106477; 20170106570; 20170106593; 20170107385; 20170107636; 20170107764; 20170107821; 20170108780; 20170110728; 20170110760; 20170113303; 20170113416; 20170114233; 20170115594; 20170119531; 20170120326; 20170120332; 20170120333; 20170120334; 20170120335; 20170120336; 20170120337; 20170120359; 20170120370; 20170120376; 20170120377; 20170120385; 20170120386; 20170120387; 20170120393; 20170120416; 20170120518; 20170120519; 20170120529; 20170120530; 20170120537; 20170120538; 20170122322; 20170123222; 20170123237; 20170125908; 20170125909; 20170125910; 20170126087; 20170128174; 20170128961; 20170129049; 20170129052; 20170129060; 20170129168; 20170129180; 20170129184; 20170129185; 20170129806; 20170130591; 20170130599; 20170131034; 20170135909; 20170136540; 20170136541; 20170136542; 20170136543; 20170136545; 20170136574; 20170136578; 20170136603; 20170136699; 20170136708; 20170137327; 20170138164; 20170139082; 20170143315; 20170144219; 20170144223; 20170144224; 20170144248; 20170144250; 20170144254; 20170145578; 20170145584; 20170145586; 20170148562; 20170148723; 20170151631; 20170151718; 20170151719; 20170154713; 20170155309; 20170156878; 20170157850; 20170159447; 20170162701; 20170162790; 20170164700; 20170165532; 20170165751; 20170165752; 20170165753; 20170165754; 20170165781; 20170165790; 20170165791; 20170165792; 20170165916; 20170166730; 20170167000; 20170167270; 20170167274; 20170173628; 20170173681; 20170173683; 20170173688; 20170173691; 20170173692; 20170173693; 20170173694; 20170173695; 20170173696; 20170173697; 20170173735; 20170173736; 20170173737; 20170173747; 20170173868; 20170173872; 20170173874; 20170173877; 20170173878; 20170173879; 20170173883; 20170173892; 20170174545; 20170174565; 20170175260; 20170175756; 20170176977; 20170179482; 20170181291; 20170182556; 20170182558; 20170182560; 20170182594; 20170182596; 20170182598; 20170183257; 20170183497; 20170183870; 20170186143; 20170189553; 20170189961; 20170189962; 20170189963; 20170189964; 20170189965; 20170191177; 20170194263; 20170194686; 20170197246; 20170197278; 20170197330; 20170197359; 20170197875; 20170203355; 20170203363; 20170203364; 20170203365; 20170203387; 20170203391; 20170203406; 20170203408; 20170203517; 20170205145; 20170209908; 20170209923; 20170209929; 20170209931; 20170209954; 20170209958; 20170209963; 20170210070; 20170210144; 20170210662; 20170211331; 20170211990; 20170212088; 20170214062; 20170216916; 20170216921; 20170216962; 20170216966; 20170217093; 20170217095; 20170217105; 20170217181; 20170218228; 20170219855; 20170220031; 20170225227; 20170225228; 20170225229; 20170225393; 20170225394; 20170225398; 20170226362; 20170227800; 20170229731; 20170231783; 20170231873; 20170231874; 20170232511; 20170232513; 20170232514; 20170232515; 20170232518; 20170232519; 20170232549; 20170232552; 20170232557; 20170232637; 20170232674; 20170232682; 20170233287; 20170233574; 20170234138; 20170234150; 20170234537; 20170235852; 20170237306; 20170239718; 20170239719; 20170239720; 20170239721; 20170239722; 20170239723; 20170239724; 20170239725; 20170239752; 20170239887; 20170239891; 20170239892; 20170241830; 20170242424; 20170243900; 20170246682; 20170246689; 20170246709; 20170246804; 20170247785; 20170248319; 20170249440; 20170252271; 20170252787; 20170252806; 20170252812; 20170252813; 20170252814; 20170252815; 20170252816; 20170252817; 20170252818; 20170252819; 20170252820; 20170252846; 20170252851; 20170252854; 20170252860; 20170252967; 20170252978; 20170253523; 20170259502; 20170260865; 20170266081; 20170266759; 20170266879; 20170271674; 20170271837; 20170274454; 20170274456; 20170274591; 20170276023; 20170278975; 20170282246; 20170282247; 20170282296; 20170282297; 20170282455; 20170284676; 20170285227; 20170287685; 20170288224; 20170290746; 20170291077; 20170291260; 20170291261; 20170291263; 20170291362; 20170292174; 20170292195; 20170294288; 20170294291; 20170296441; 20170296442; 20170297097; 20170297098; 20170297099; 20170297100; 20170297101; 20170297102; 20170297103; 20170297104; 20170297106; 20170297108; 20170297109; 20170297111; 20170297267; 20170297275; 20170297674; 20170299181; 20170299973; 20170304894; 20170304895; 20170304896; 20170304897; 20170304900; 20170304933; 20170304944; 20170304945; 20170304946; 20170304947; 20170306221; 20170306447; 20170306448; 20170306449; 20170306450; 20170306457; 20170306458; 20170306459; 20170306460; 20170306766; 20170307859; 20170309710; 20170312821; 20170312822; 20170312826; 20170312857; 20170312858; 20170312984; 20170312985; 20170314109; 20170314114; 20170315538; 20170317259; 20170317336; 20170320162; 20170320168; 20170320264; 20170320277; 20170320773; 20170322173; 20170322487; 20170323627; 20170326668; 20170326681; 20170326690; 20170326788; 20170326797; 20170326805; 20170326816; 20170330674; 20170332733; 20170333295; 20170333994; 20170333995; 20170334023; 20170334024; 20170334133; 20170334136; 20170334725; 20170335436; 20170336149; 20170336155; 20170338392; 20170338472; 20170341141; 20170341142; 20170341175; 20170341182; 20170341183; 20170341325; 20170341451; 20170342303; 20170342535; 20170348201; 20170348202; 20170348458; 20170348792; 20170348906; 20170348909; 20170349756; 20170350259; 20170354805; 20170354806; 20170355135; 20170355138; 20170355146; 20170355147; 20170355855; 20170356068; 20170358685; 20170358795; 20170360534; 20170361405; 20170362119; 20170362687; 20170363011; 20170365473; 20170365843; 20170365853; 20170368603; 20170368640; 20170368644; 20170368647; 20170368740; 20170368816; 20180000501; 20180000502; 20180000503; 20180000571; 20180001423; 20180001424; 20180001547; 20180001553; 20180001556; 20180001557; 20180001567; 20180006293; 20180009007; 20180009054; 20180009064; 20180009134; 20180010001; 20180010221; 20180010237; 20180014844; 20180015564; 20180015565; 20180015566; 20180019458; 20180021473; 20180021877; 20180021878; 20180022022; 20180022065; 20180022640; 20180026171; 20180027615; 20180027616; 20180029124; 20180029125; 20180029241; 20180029294; 20180029295; 20180029306; 20180031028; 20180036939; 20180036945; 20180036953; 20180037546; 20180038167; 20180038995; 20180040916; 20180042718; 20180043455; 20180043467; 20180044523; 20180047696; 20180050390; 20180050423; 20180050490; 20180050493; 20180050495; 20180052087; 20180052254; 20180055641; 20180056389; 20180056390; 20180056391; 20180056392; 20180056396; 20180056446; 20180057142; 20180057659; 20180061279; 20180065144; 20180065178; 20180065181; 20180065182; 20180065186; 20180065208; 20180065209; 20180065295; 20180065298; 20180065300; 20180065304; 20180065305; 20180065306; 20180065307; 20180065308; 20180065309; 20180065316; 20180065317; 20180065318; 20180065320; 20180065322; 20180066358; 20180066603; 20180067464; 20180070458; 20180071175; 20180071819; 20180071821; 20180071825; 20180071949; 20180071986; 20180071988; 20180071989; 20180072040; 20180072613; 20180072630; 20180073532; 20180078936; 20180079003; 20180079029; 20180079033; 20180079034; 20180079125; 20180083266; 20180083281; 20180083282; 20180083289; 20180085605; 20180085826; 20180085856; 20180085998; 20180086004; 20180086025; 20180087157; 20180088399; 20180088462; 20180089824; 20180093325; 20180093347; 20180093418; 20180093419; 20180094953; 20180095450; 20180096175; 20180098919; 20180099307; 20180099331; 20180099333; 20180102543; 20180104770; 20180105903; 20180111191; 20180111193; 20180111194; 20180111195; 20180111196; 20180111197; 20180111198; 20180111219; 20180111317; 20180111318; 20180111319; 20180111320; 20180111334; 20180113445; 20180115072; 20180116762; 20180117674; 20180117675; 20180117713; 20180117845; 20180122541; 20180122629; 20180124341; 20180125365; 20180126460; 20180126461; 20180126462; 20180126487; 20180126637; 20180126638; 20180126639; 20180126640; 20180126641; 20180126642; 20180126648; 20180126649; 20180126650; 20180126655; 20180126666; 20180126720; 20180127317; 20180128803; 20180131040; 20180133583; 20180133801; 20180133804; 20180133839; 20180133840; 20180133956; 20180133958; 20180134027; 20180136367; 20180136458; 20180141119; 20180141123; 20180141126; 20180141127; 20180141159; 20180141160; 20180141162; 20180141174; 20180141235; 20180141274; 20180141305; 20180143147; 20180144934; 20180147627; 20180147628; 20180147653; 20180147654; 20180147655; 20180147669; 20180147779; 20180148378; 20180148379; 20180148380; 20180148585; 20180149039; 20180149196; 20180151048; 20180153205; 20180154437; 20180154438; 20180154439; 20180154440; 20180154441; 20180154442; 20180154443; 20180154444; 20180154484; 20180154574; 20180154580; 20180154591; 20180154657; 20180159016; 20180161873; 20180161874; 20180161875; 20180161931; 20180161932; 20180161934; 20180161935; 20180161954; 20180162013; 20180162044; 20180162047; 20180162048; 20180162053; 20180162771; 20180163311; 20180166251; 20180166665; 20180168254; 20180168294; 20180169351; 20180169756; 20180169784; 20180169950; 20180169951; 20180169952; 20180169960; 20180169970; 20180170107; 20180170914; 20180171873; 20180172369; 20180175333; 20180178284; 20180178285; 20180178286; 20180178287; 20180178288; 20180178325; 20180178326; 20180178413; 20180178491; 20180179332; 20180179956; 20180180803; 20180180812; 20180180813; 20180180874; 20180180896; 20180183062; 20180185098; 20180185875; 20180185893; 20180185921; 20180185961; 20180185965; 20180186067; 20180186078; 20180186080; 20180186081; 20180186082; 20180186120; 20180187569; 20180187982; 20180193916; 20180193923; 20180193953; 20180193954; 20180193955; 20180194080; 20180195186; 20180195684; 20180200790; 20180200791; 20180200792; 20180200793; 20180200794; 20180200796; 20180200797; 20180200798; 20180200800; 20180200836; 20180200960; 20180202076; 20180202234; 20180202293; 20180207725; 20180207749; 20180207750; 20180207850; 20180207862; 20180207863; 20180207865; 20180207866; 20180207868; 20180208762; 20180208785; 20180209057; 20180209381; 20180209498; 20180212184; 20180212250; 20180214351; 20180214874; 20180214946; 20180214947; 20180214950; 20180214951; 20180214955; 20180214984; 20180214985; 20180215094; 20180215103; 20180215644; 20180216501; 20180219254; 20180221948; 20180221949; 20180221950; 20180221953; and 20180221985.; 20180226917; 20180228570; 20180228612; 20180228613; 20180228701; 20180228737; 20180229300; 20180229434; 20180229436; 20180236546; 20180236551; 20180237325; 20180237329; 20180237567; 20180240691; 20180243094; 20180243097; 20180243977; 20180243991; 20180244127; 20180244862; 20180244863; 20180250737; 20180250739; 20180250742; 20180250743; 20180250744; 20180250745; 20180250746; 20180250771; 20180250772; 20180250773; 20180250774; 20180250775; 20180250890; 20180251645; 20180252398; 20180257138; 20180257140; 20180257297; 20180264549; 20180264551; 20180264598; 20180264679; 20180264719; 20180264778; 20180265417; 20180265738; 20180266773; 20180267373; 20180272464; 20180272600; 20180272610; 20180272652; 20180273422; 20180273425; 20180273707; 20180275634; 20180281236; 20180281237; 20180281282; 20180281283; 20180281284; 20180281294; 20180282604; 20180289493; 20180290212; 20180290373; 20180291195; 20180296343; 20180297113; 20180297114; 20180297117; 20180297272; 20180297296; 20180303491; 20180303616; 20180304353; 20180304359; 20180304360; 20180304361; 20180304363; 20180304364; 20180304365; 20180304369; 20180304370; 20180304537; 20180304540; 20180305266; 20180307209; 20180309202; 20180311731; 20180311735; 20180311738; 20180312660; 20180318657; 20180318922; 20180318925; 20180318928; 20180318932; 20180318933; 20180319108; 20180319132; 20180319150; 20180320006; 20180323514; 20180326488; 20180326663; 20180326664; 20180326665; 20180326668; 20180328224; 20180333911; 20180333912; 20180333913; 20180335659; 20180337110; 20180338196; 20180345367; 20180345382; 20180345405; 20180345575; 20180345576; 20180353391; 20180354304; 20180354860; 20180355199; 20180360609; 20180361510; 20180361660; 20180361661; 20180361666; 20180361668; 20180361674; 20180363361; 20180369914; 20180369915; 20180369918; 20180369960; 20180370114; 20180370120; 20180370125; 20180370131; 20180370147; 20180370846; 20180370860; 20180371244; 20180374262; 20190000166; 20190001412; 20190001553; 20190001563; 20190001564; 20190001570; 20190001576; 20190002353; 20190009472; 20190010270; 20190011063; 20190017185; 20190019736; 20190020105; 20190022427; 20190022428; 20190022725; 20190022926; 20190022979; 20190023561; 20190026499; 20190030498; 20190030601; 20190030602; 20190030605; 20190030809; 20190030810; 20190030811; 20190031844; 20190031908; 20190031911; 20190033719; 20190033737; 20190039182; 20190039183; 20190039294; 20190039367; 20190047047; 20190047050; 20190047212; 20190047214; 20190047277; 20190077077; 20190084222; 20190096625; 20190105712; 20190118259; 20190118261; 20190160539; 20190170444; 20190177212; 20190202007; 20190210252; 20190224753; 20190228986; 20190232366; 20190240658; 20190275612; 20190275737; 20190276918; 20190283184; 20190299290; 20190300417; 20190308244; 20190315053; 20190315062; 20190315063; 20190344497; 20190344555; 20190346140; 20190352221; 20200025462; 20200039000; 20200040749; 20200043901; 20200047288; 20200047410; 20200048075; 20200049415; 20200076262; 20200094322; 20200108465; 20200140297; 20200144627; 20200144628; 20200144633; 20200144635; 20200144646; 20200144647; 20200144648; 20200144653; 20200144654; 20200156104; 20200176803; 20200182549; 20200189037; 20200198226; 20200215758; 20200227763; 20200230905; 20200230937; 20200235409; 20200235410; 20200254567; 20200255959; 20200255962; 20200255963; 20200259186; 20200261977; 20200269505; 20200276638; 20200298520; 20200298652; 20200324338; 20200333295; 20200338639; 20200361148; 20200370439; 20200398457; 20200406345; 20210000575; 20210025325; 20210025405; 20210039166; 20210039323; 20210069786; 20210069791; 20210071968; 20210078079; 20210146616; 20210148239; 20210154771; 20210156304; 20210162659; 20210170495; 20210175146; 20210178480; 20210178665; 20210180165; 20210197502; 20210205890; 20210252781; 20210260826; 20210269596; 20210277232; 20210283850; 20210284570; 20210301673; 20210308762; 20210308805; 20210355570; 20210362416; 20210379817; 20210394268; International and foreign patent publication Nos. WO2011123195A1; DE102013207656A1; EP3417386A1; WO2019055181A1; WO2019055576A1; WO2019055538A1; WO2019212482A1; WO2019212481A1 ; WO2020046290A1; WO2021140000A1; GB201718627D0; GB2572327A; and EP3597332A1.

What is claimed is:

1. A manufacturing method for selectively heating portions of defined portions of a surface of a substrate with an energy source configured to direct concentrated energy on a defined portion of the surface of the substrate, to cause heating and thermal stress in the defined portions, the method comprising:
exposing a first portion of the surface of the substrate to the concentrated energy to cause the heating and the thermal stress proximate to the first portion; and
exposing a second portion of the surface of the substrate adjacent to the first portion to the concentrated energy to cause the heating and the thermal stress proximate to the second portion,
wherein a latency between heating of the first portion and before heating the adjacent second portion is selectively dependent on a peak temperature of the substrate, and a thermal stress proximate to the first portion.

2. The manufacturing method according to claim 1, where during the latency, a third portion of the surface of the substrate which is not adjacent to the first portion and is not adjacent to the second portion is exposed to the concentrated energy to cause the heating and the thermal stress proximate to the third portion.

3. The manufacturing method according to claim 2, wherein a spatial relation of the third portion to the first portion is dependent on at least a temperature change of the first portion during the heating of the third portion of the layer, and a thermal stress on the substrate.

4. The manufacturing method according to claim 2, wherein a repositioning of the concentrated energy from the first portion to the third portion occurs prior to the first portion exceeding a predetermined threshold temperature and exceeding a predetermined threshold thermal stress in the first portion.

5. The manufacturing method according to claim 1, wherein the concentrated energy causes a phase transition in the defined portion.

6. The manufacturing method according to claim 1, further comprising depositing a layer on a substrate before exposing the first portion.

7. The manufacturing method according to claim 6, wherein the deposited layer comprises a meltable, fusible or sinterable powder, and the concentrated energy is adapted to cause melting, fusion or sintering of the powder.

8. The method according to claim 1, wherein the energy source comprises at least one of a laser and an electron beam.

9. The method according to claim 1, wherein the substrate comprises an integrated circuit.

10. The method according to claim 1, wherein the peak temperature of the substrate, and the thermal stress proximate to the first portion are calculated by an automated control dependent on material properties of the layer and the substrate.

11. A material processing manufacturing method, comprising:
defining a series of segments for treatment, each segment representing a region to be selectively heated to process a layer on a surface of a substrate; and
automatically checking each successive segment to control a thermal overlap with prior heated segments, wherein:
if a temperature or thermal stress would exceed a threshold as a result of the heating of the respective segment, a spatially distant segment is selected as the next successive segment of the series of segments, and
if the temperature or thermal stress would not exceed the threshold as a result of the heating of the respective segment, a spatially proximate segment is selected as the next successive segment of the series of segments.

12. The method according to claim 11, further comprising planning a sequence and timing of the selective heating of respective segments with Multiphysics simulations that impose criteria to assure that the defined series of segments does not exceed a maximum temperature, maximum thermal gradient, and a maximum stress.

13. The method according to claim 12, wherein a repositioning of the heating between successive segments incurs a distance-related latency, and the sequence and timing of the selective heating is planned to minimize a material processing duration.

14. The method according to claim 11, further comprising measuring an in situ temperature, and selectively dependent on the measured in situ temperature, imposing a pause before heating a respective segment if a temperature adjacent to the segment exceeds a threshold.

15. The method according to claim 11, wherein process constraints are determined empirically based on properties of the layer and properties of the substrate.

16. The method according to claim 11, wherein process constraints are determined empirically based on properties of the layer and geometry of the prior melted segments.

17. The method according to claim 11, wherein the material processing comprises an additive manufacturing process, and the selective heating melts, fuses or sinters particles deposited on the surface of the substrate to form the layer.

18. An automated controller for controlling an additive manufacturing process employing an energy source for directing concentrated energy toward a layer on a substrate, the energy source being adapted to cause localized heating of a portion of the layer, a phase change of the portion of the layer, and a residual stress proximal to an interface between the substrate and the portion of the phase transitioned layer, the automated controller executing non-transitory instructions to:
position the concentrated energy in a first series of adjacent positions in a first region of the substrate, to cause the localized heating of the first region, the phase transition, and the residual stress proximal to the interface between the substrate and the first portion of the phase transitioned layer, under conditions which are predicted to approach but not exceed a threshold temperature criterion and a stress criterion of the first region, wherein additional localized heating would exceed the threshold temperature criterion;
reposition the concentrated energy in a second series of adjacent positions in a second region of the substrate sufficiently distant from the first region such that the first region cools while the second portion is being heated, to cause the localized heating of the second region, the phase transition, and the residual stress proximal to the interface between the substrate and the second portion of the phase transitioned layer; and
reposition the concentrated energy in a third series of adjacent positions in the first region of the substrate after the cooling of the first region, to cause the heating of the first region, the phase transition, and the residual stress proximal to the interface between the substrate and the first portion of the phase transitioned layer, under conditions which are predicted to approach but not exceed the threshold temperature criterion and the stress criterion of the first region, while the second region cools.

19. The automated controller according to claim 18, wherein the non-transitory instructions comprise instructions for planning a sequence and timing of the concentrated energy with Multiphysics simulations that impose criteria to assure that the defined series of segments does not exceed a maximum temperature, maximum thermal gradient, and a maximum stress.

20. The automated controller according to claim 18, wherein the non-transitory instructions comprise instructions for automatically checking a thermal overlap between a respective position and prior heated positions.
